(19) United States
(12) Patent Application Publication
(10) Pub. No.: US 2026/0220606 A1
(43) Pub. Date: Jul. 30, 2026

(54) RESOURCE MANAGEMENT SYSTEMS AND METHODS

(71) Applicant: DeLorean Artificial Intelligence, Inc., Palm Beach, FL (US)

(72) Inventors: Dhiraj Sharma, Palm Beach, FL (US); Severence M. MacLaughlin, Palm Beach, FL (US); Ram Prasad Bora, Palm Beach, FL (US)

(21) Appl. No.: 19/038,132

(22) Filed: Jan. 27, 2025

(51) Int. Cl. G06Q 10/1053; G06F 16/334

(52) U.S. Cl. CPC G06Q 10/1053; G06F 16/3347

(57) ABSTRACT

Techniques for workforce management that include: vectorizing documents associated with workers to generate vector representations of the documents; generating, based on the vector representations of the documents, worker vector sets; generating, based on the worker vector sets, labeled worker datasets comprising position labels; clustering, based on the position labels, the labeled worker datasets to determine position clusters; determining, based on the labeled worker datasets, an attribute vector set for a given position; obtaining candidate documents associated with a candidate worker; vectorizing the candidate documents to generate vector representations of the candidate documents; generating, based on the vector representations of the documents, a candidate worker vector set; comparing the candidate worker vector set to the attribute vector set for the given position to determine whether the candidate worker associated with the candidate worker vector set is qualified for the given position.

### FIELD

Embodiments relate generally to managing diverse resources and more particularly to systems and methods for assessing and implementing workforce management.

### BACKGROUND

In today's dynamic and evolving business environment, effective workforce management plays a crucial role in the success of organizations. For example, human resource (HR) departments are often responsible for a broad range of workforce management functions, including recruitment, onboarding, training and development, performance management, and regulatory compliance. These activities can be essential in building and maintaining a productive workforce while fostering a positive workplace culture. The recruitment process, for instance, typically involves screening large volumes of applicants, identifying top candidates, and ensuring their smooth transition into the organization. HR teams are often responsible for a variety of tasks, such as maintaining ongoing employee engagement, managing employee performance, ensuring fair compensation, and providing opportunities for growth and development to retain top talent. Moreover, HR professionals may have to navigate an ever-changing legal landscape, staying compliant with labor laws and regulations that vary across regions and industries.

### SUMMARY

The responsibilities of HR departments and related business units often require significant time, attention to detail, and the handling of large volumes of data. As businesses grow and the demands on HR departments increase, organizations frequently encounter significant challenges to efficiently managing these tasks. A prominent challenge is managing talent development, especially within hiring and promotion processes.

In the context of employee assessments and promotions in an HR department, HR personnel (or other workforce administrators) may conduct employee assessments to evaluate the performance, skills, and growth potential of existing employees (or other workers). For instance, they may use performance review systems that involve goal-setting and periodic check-ins to assess how well employees meet organizational expectations and to generate associated performance reviews or other documentation of employee performance. These assessments may be based on quantitative metrics, such as achievement of targets, as well as qualitative feedback from supervisors and peers. If an employee consistently performs well and demonstrates leadership potential, HR personnel might recommend them for promotion. This recommendation may involve HR drafting a workforce management plan that includes a promotion proposal, setting up a meeting with upper management for approval, and subsequently communicating the decision to the employee. The process may also include adjusting the employee's responsibilities, setting new goals, and providing training as part of the transition.

In the context of screening and hiring candidates to address staffing needs, HR personnel (or other workforce administrators) may oversee recruitment by screening and hiring qualified candidates. Their tasks may include posting job openings (e.g., creating and publishing job listings that define key qualifications, job roles, and responsibilities), screening resumes (e.g., reviewing applications, shortlisting qualified candidates, and managing applicant flow), conducting interviews (e.g., organizing and conducting preliminary interviews, assessing candidates'skills, experience, and fit with company culture, and arranging for follow-up interviews with relevant department heads or teams), and onboarding new hires (e.g., once a candidate is selected, the HR team may facilitate onboarding by providing training, company policies, and resources to support smooth integration into the organization).

In the context of hiring temporary nurses for a healthcare facility, HR personnel (or other workforce administrators) may need to hire temporary nurses to address staffing shortages. This may involve identifying staffing needs (e.g., workforce administrators working with nursing supervisors to determine the number of temporary nurses needed, departments in need of support, and the shifts to be covered), screening candidates (e.g., posting job openings for temporary nurses and specifying requirements such as state licensure, specialization, and prior experience, potentially partnering with staffing agencies or using job boards to reach a larger pool of qualified candidates), conducting interviews and credential verification (e.g., screening applicants to ensure they meet healthcare standards, including conducting background checks, verifying certifications, and conducting interviews to assess bedside manner and suitability for the role), and onboarding and orientation (e.g., once candidates are selected, HR may provide an orientation on facility protocols, patient management practices, and emergency procedures, ensuring temporary nurses are fully briefed on the specific protocols of the healthcare facility to support seamless patient care). In the context of a healthcare facility, having a mixed workforce—including full-time nurses, temporary nurses, and contract-based specialists—may enable the organization to respond dynamically to patient needs, optimize costs, and maintain high-quality care standards. This type of flexibility can be vital in industries where demand is variable and requires immediate response capabilities.

With companies often receiving hundreds or even thousands of applications for a single position, HR professionals must sift through vast amounts of resumes, cover letters, application data, and similar documentation to identify qualified candidates. This process is time-consuming and prone to human bias, which can inadvertently lead to suboptimal hiring decisions. Similarly, the process of identifying workers who are ready for promotions or new opportunities within the organization is often subjective and based on incomplete or inconsistent performance data, leading to potential oversights and dissatisfaction among workers. These challenges are further compounded when organizations incorporate additional considerations, such as diversity and inclusion in hiring and promotions, which can require careful analysis of demographic data and addressing biases that can arise unintentionally. The sheer scale and complexity of these tasks can overwhelm HR departments, making it difficult to ensure fairness, efficiency, and optimal decision-making in a timely manner.

Provided are embodiments for assessing and implementing workforce management. In some embodiments, techniques are employed to assist HR departments with common functions, such as talent development, including hiring and promotion processes. In some embodiments, employment data, including documents, such as evaluations, resumes, work product, or other documents associated with existing workers, are collected and vectorized to generate representative document vectors. The workers are then grouped into worker clusters, and cluster profiles are generated for the various worker clusters based on representative document vectors for the documents associated with workers in the cluster. The cluster profiles may include, for example, a vector for each of one or more relevant attributes of the cluster. In some embodiments, attribute vectors of a cluster profile associated with a position are compared to attribute vectors associated with candidates for a position to identify candidates that are suited for the position. For example, in the case of recruiting highly qualified trauma nurses, an worker cluster may be representative of highly rated trauma nurses, the relevant attributes for the worker cluster may be identified as years of experience as a nurse, years of experience as a trauma nurse, number of prior trauma nurse positions, performance ratings, number of relevant industry certifications, industry accolades, and similar attributes, and the cluster profile may include a corresponding cluster attribute vector for each attribute (e.g., an average of the corresponding attribute vectors for the workers in the cluster) that is based on evaluations, resumes, work product, or other documents associated with the nurses represented in the cluster. Candidate data, such evaluations, resumes, work product, or other documents associated with candidates for a trauma nurse position may be vectorized, one or more candidate worker attribute vectors may be generated for each candidate, and the candidate worker attribute vectors may be matched or otherwise compared with the attribute vectors of the cluster profile to identify the most qualified candidates for the trauma nurse position. Such an embodiment, including the use of vectors and associated matching may provide a holistic view of groups and individuals, facilitating efficient identification and selection of qualified individuals. For example, in contrast to “keyword” identification and matching that can be skewed by use (or non-use) of certain words, the clustering and vectorization may provide a more holistic representation of worker groups and candidates that can reduce unintentional bias in talent assessment and selection.

Although certain embodiments are described within the context of workforce management and HR operations for illustrative purposes, the disclosed embodiments may be employed in any suitable context. For instance, these embodiments may be applied in contexts such as identifying individuals for inclusion in a group, selecting candidates for academic programs, or in industries including healthcare, corporate environments, manufacturing, or the like.

### BRIEF DESCRIPTION OF THE DRAWINGS

FIG. 1 is a diagram illustrating a workforce environment in accordance with one or more embodiments.

FIG. 2 is a flow diagram illustrating operational aspects of a workforce management system in accordance with one or more embodiments.

FIGS. 3A and 3B are diagrams illustrating an example workforce management plan in accordance with one or more embodiments.

FIG. 4 is a diagram illustrating an example position request in accordance with one or more embodiments.

FIG. 5 is a flowchart diagram illustrating a method of workforce management in accordance with one or more embodiments.

FIG. 6 is a diagram illustrating an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided are embodiments for assessing and implementing workforce management. In some embodiments, techniques are employed to assist HR departments with common functions, such as talent development, including hiring and promotion processes. In some embodiments, employment data, including documents, such as evaluations, resumes, work product, or other documents associated with existing workers, are collected and vectorized to generate representative document vectors. The workers are then grouped into worker clusters, and cluster profiles are generated for the various worker clusters based on representative document vectors for the documents associated with workers in the cluster. The cluster profiles may include, for example, a vector for each of one or more relevant attributes of the cluster. In some embodiments, attribute vectors of a cluster profile associated with a position are compared to attribute vectors associated with candidates for a position to identify candidates that are suited for the position. For example, in the case of recruiting highly qualified trauma nurses, an worker cluster may be representative of highly rated trauma nurses, the relevant attributes for the worker cluster may be identified as years of experience as a nurse, years of experience as a trauma nurse, number of prior trauma nurse positions, performance ratings, number of relevant industry certifications, industry accolades, and similar attributes, and the cluster profile may include a corresponding cluster attribute vector for each attribute (e.g., an average of the corresponding attribute vectors for the workers in the cluster) that is based on evaluations, resumes, work product, or other documents associated with the nurses represented in the cluster. Candidate data, such evaluations, resumes, work product, or other documents associated with candidates for a trauma nurse position may be vectorized, one or more candidate worker attribute vectors may be generated for each candidate, and the candidate worker attribute vectors may be matched or otherwise compared with the attribute vectors of the cluster profile to identify the most qualified candidates for the trauma nurse position. Such an embodiment, including the use of vectors and associated matching may provide a holistic view of groups and individuals, facilitating efficient identification and selection of qualified individuals. For example, in contrast to “keyword” identification and matching that can be skewed by use (or non-use) of certain words, the clustering and vectorization may provide a more holistic representation of worker groups and candidates that can reduce unintentional bias in talent assessment and selection.

Although certain embodiments are described within the context of workforce management and HR operations for illustrative purposes, the disclosed embodiments may be employed in any suitable context. For instance, these embodiments may be applied in contexts such as identifying individuals for inclusion in a group, selecting candidates for academic programs, or in industries including healthcare, corporate environments, manufacturing, or the like.

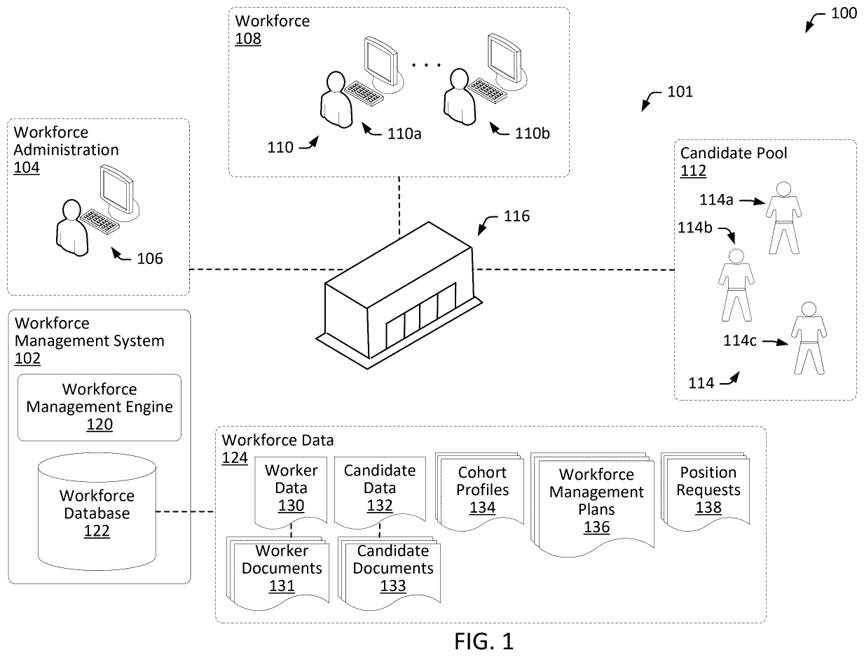

FIG. 1 is a diagram illustrating a workforce environment 100 in accordance with one or more embodiments. In the illustrated embodiment, the workforce environment 100 includes a workforce system 101 including a workforce management system (“management system”) 102, a workforce administration 104 (e.g., including workforce administrators 106), a workforce 108 including workers 110 (e.g., including workers 110a and 110b), and a candidate pool 112, including candidate workers 114 (e.g., including candidate workers 114a, 114b, and 114c) associated with an organization 116 (e.g., a healthcare business). The management system 102 includes a workforce management engine 120 and a workforce database 122 storing workforce data 124, including worker data 130 (e.g., including worker document 131), candidate data 132 (e.g., including candidate document 133), worker cohort profiles 134 (e.g., worker talent profiles or the like), workforce management plans 136, and position requests 138 (e.g., job postings or the like).

In some embodiments, the workforce administration 104 includes a set of electronic systems and personnel responsible for overseeing the efficient management of the workforce 108 of the organization 116. For example, the workforce administration 104 may include and employ workforce administrators 106 and the workforce management system 102 to implement efficient management of the workforce 108, including tasks, such as promotions of existing workers 110, hiring and onboarding of candidates 114, and the like. The workforce administration 104 may, for example, be an HR department of a business, where the workforce administrators 106 include HR personnel, such as an HR representative. Workforce administrators 106 may, for example, handle a range of HR functions such as hiring, assessing, and managing worker performance. In such an embodiment, workforce administrators 106 may, for example, include HR personnel situated within the HR department, who oversee recruitment, promotions, workforce assessments, and worker relations to ensure a well-organized and effective workforce. This may include the tasks of worker assessments and promotions by an HR department described and the tasks of screening and hiring candidates to address staffing needs described (e.g., including the tasks of a hiring temporary nurses for a healthcare facility), or the like.

In some embodiments, the workforce 108 includes all individuals (e.g., workers 110) who provide their skills, expertise, and labor to fulfill the operational and strategic needs of the organization 116. For example, the workforce 108 may include workers 110 who are hired to perform tasks for operating the organization 116. The workforce 108 may involve a variety of roles and worker arrangements, such as employees, contractors, freelancers, and temporary workers. For example, workers 110 may include full-time employees of the organization 116, part-time employees of the organization 116, contractors hired by the organization 116, or the like. In the context of the organization 116 being a hospital that employs workers 110 including full-time and part-time nurses, and that hires temporary workers 110 including temporary nurses (e.g., nurses hired through healthcare staffing agencies, to provide flexibility and support for a specific period, such as during staff shortages, without a long-term commitment), the workforce 108 may include these full-time, part-time, and temporary nurses.

In some embodiments, the candidate pool 112 is a group of qualified and available individuals (e.g., candidates 114) that the organization 116 considers for potential employment or contract work to meet its workforce needs. Employee-type worker candidates in the candidate pool 112 may be individuals seeking long-term, stable positions with benefits, often with full-time hours. Contractor-type worker candidates in the candidate pool 112 may be professionals available for project-based or fixed-term assignments. Temporary-type worker candidates in the candidate pool 112 may be people considered for short-term assignments or seasonal roles, especially useful when a business faces fluctuating demand. In the context of the organization 116 being a hospital, the candidate pool 112 may include temporary nurses (e.g., licensed practical nurses (LPNs), registered nurses (RNs), and nurse practitioners (NPs) that are open to short-term contracts and willing to work in high-demand areas, such as emergency departments or intensive care unit, or the like). Such a temporary nurse candidate pool 112 may, for example, be managed in collaboration with healthcare staffing agencies or maintained by the hospital's HR department. In some embodiments, the candidate pool 112 includes current workers 110 of the organization 116. For example, in the case of assessing workers for promotions, an HR department may identify a group of existing employees that are eligible for the promotion, and the candidate pool 112 for the promotion includes the existing employees that are eligible for the promotion. As another example, in the case of assessing workers for a position within the organization (e.g., changing roles, receiving a promotion, or the like), the HR department may identify a group of existing employees that are eligible as candidates for the promotion, and designate a candidate pool 112 for the position that includes the group of employees.

In some embodiments, management system 102 is operable to perform some operations described here, including those relating to selection of candidates to fill various work positions (or “jobs”). For example, in some embodiments, management system 102 is operable to obtain worker data 130 (e.g., resumes, performance review, work product, or other documents associated with the workers 110), vectorize the worker data 130 to generate vector representations of the worker data 130 (e.g., generate vectors representing the documents or other data associated with the workers 110), generate labeled worker datasets for workers 110 that include a vector representation of the worker data 130 associated with a worker 110 and a position label that corresponds to a position (or “job”) held by the worker 110, cluster the labeled worker datasets for the workers 110 to determine position clusters associated with various positions held by the workers 110, and determine worker cohort profiles 134 (e.g., talent profiles) that include vector representations of attributes for various worker cohorts (e.g., workers with the same positions or the like) based on the vector representations associated with corresponding position clusters. Such a vector-based technique may provide for the generation of a relatively holistic representation of worker groups that can incorporate and emphasize useful worker attributes that may otherwise go unnoticed and exclude or deemphasize less useful worker attributes, such as those potentially introduced through unintentional bias in worker assessment.

In some embodiments, management system 102 is operable to obtain candidate data 132 (e.g., resumes, performance reviews, work product, or other documents associated with the candidate worker 114a), vectorize the candidate data 132 to generate a vector representation of the candidate 114 (e.g., generate a vector representation of the candidate 114a based on a vector representation of the candidate data 132), and compare the vector representation of the candidate 114 to vector representations of attributes of worker cohort profiles 134 (e.g., talent profiles) for various positions, to determine whether the candidate 114 is qualified for one or more of the various positions. In some embodiments, if a candidate 114 is determined to be qualified for a position, an offer for the position may be extended to the candidate, or the candidate 114 may be included in a pool of candidates that are considered qualified for the position. In some embodiments, if a candidate 114 is determined not to be not qualified for a position, an offer for the position may not be extended to the candidate, or the candidate 114 may otherwise be excluded from holding the position. Such a vector-based technique may provide a relatively holistic representation of candidates that can incorporate and emphasize useful worker attributes that may otherwise go unnoticed while excluding or de-emphasizing less relevant worker attributes, such as those potentially resulting from unintentional bias in candidate assessment.

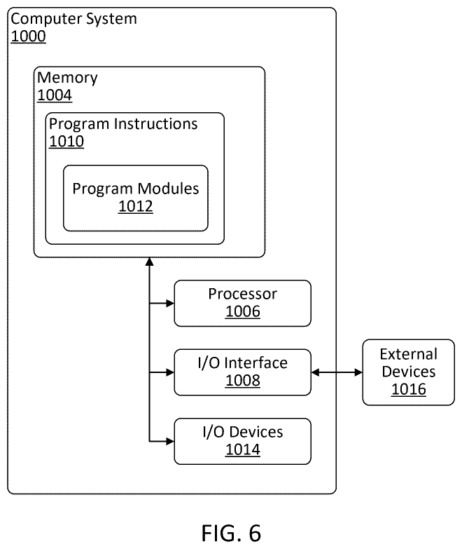

In some embodiments, the workforce management engine 120 is operable to execute tasks described, such as those described as being performed by the management system 102. For example, the workforce management engine 120 may be a software module that is operable to perform processes relating to obtaining data, vectorizing data, clustering data, vector matching, publishing data, or the like, as described here. In some embodiments, the management system 102 includes a computer system that is the same or similar to computer system 1000 described with regard to at least FIG. 6.

In some embodiments, the workforce database 122 is a memory device operable to store data. For example, the workforce database 122 may be a memory device that stores the workforce data 124. The workforce database 122 may, for example, be a structured and organized collection of data (e.g., workforce data 124) stored electronically, and designed to facilitate efficient data retrieval, management, and manipulation. The database may utilize tables, schemas, and relationships that define how data is stored and interconnected, providing a systematic way to organize, search, and retrieve information based on specific queries or criteria.

In some embodiments, worker data 130 includes data that is indicative of attributes of workers 110 (“worker attributes”), such as those currently or formerly employed by the organization 116. For example, worker data 130 may include worker documents 131, such as worker records, including resumes, performance evaluations, work product, analytics data, or the like for one or more of the workers 110, or other types of data, such as job title, that may not be contained in a document format. A worker record for a worker may include a document that contains personal details, employment dates, job titles, and compensation history for the worker. A resume for a worker may include a document that provides a concise summary of the worker's professional qualifications, experience, skills, and education. A performance evaluation for a worker may include a document that records the worker's job performance, skills, behavior, and achievements over a period. Such a document may include comprehensive feedback from supervisors and, in some cases, peers or self-assessments from the worker. For example, a performance evaluation for a worker may include data that documents general information about the worker, such as their name, job title, and review period; an overview of job-specific goals and how well these were met; evaluations of core competencies like technical skills, communication, teamwork, and work ethic; highlights of significant achievements; identification of areas for improvement and suggestions for development needs; a plan that includes a definition of goals for the upcoming period and an outline of a professional growth plan; overall ratings of the worker; comments by the worker; comments by the evaluator (e.g., comments provided by the HR representative or supervisor); or the like. Work product may include tangible outputs, documents, or digital artifacts created as a result of a worker's work activities and may vary based on the nature of the worker's position and activities. This may include, for example, reports, emails or other communications, presentations, project plans and documentation, generated by the worker. In the context of a nurse, work product may include, for example, includes documentation and records essential for patient care, communication, and healthcare compliance, such as patient care reports, care plans, shift handover notes, incident reports, or the like created by the nurse. Analytics data for a worker may include quantitative and qualitative information gathered to assess various aspects of workforce performance, engagement, and efficiency. For example, analytics data for a worker may include performance metrics (e.g., data that tracks a worker's output and achievements, often linked to specific goals or key performance indicators), productivity data (e.g., information on task completion times, efficiency rates, and hours worked to measure resource effectiveness), engagement scores (e.g., results from surveys on job satisfaction, motivation, and workplace sentiment), training and development data (e.g., information on completed skills training, professional development courses, and certifications obtained), attendance and absenteeism data (e.g., records on attendance, punctuality, and patterns in time off that highlight trends in absenteeism), turnover and retention rates (e.g., data on hiring, tenure, and reasons for worker departure to assess workforce stability), compensation and benefits data (e.g., information on salary, bonuses, and benefits usage to ensure competitive pay practices), health and safety data (e.g., records of workplace incidents, injuries, and risk factors to promote a safe work environment), or the like. In the context of a nurse worker, analytics data might include performance metrics (e.g., data tracking patient care efficiency, such as the number of patients treated or medication administration accuracy), productivity data (e.g., information on shift coverage, task completion times, and patient charting efficiency), engagement scores (e.g., results from surveys measuring job satisfaction, teamwork, and stress levels in high-pressure environments), training and development data (e.g., records of completed certifications like CPR, advanced cardiac life support, or specific patient care training), attendance and absenteeism data (e.g., patterns in sick days or overtime usage that could indicate burnout), turnover and retention rates (e.g., data on the average tenure of nurses, reasons for departure, and new hire retention), compensation and benefits data (e.g., insights into pay scales, overtime compensation, and health benefits usage), and health and safety data (e.g., records of on-the-job injuries, needle-stick incidents, and adherence to safety protocols).

In some embodiments, the worker data 130 includes structured data. Structured data may include data that is organized in a predefined model or schema, making it easily searchable and analyzable by computers. Structured data may, for example, be stored in rows and columns in relational databases or spreadsheets, where each field contains specific types of information. This format allows for efficient querying, sorting, and processing by both humans and computer systems. For example, in the context of worker data, structured data may include worker information stored in a company's HR database, where each worker's record includes specific fields, such as worker ID, name, job title, department, hire date, and salary. This structured format enables HR personnel to quickly query or filter by certain criteria—such as finding all workers in a particular department or those hired within a specific time frame—and easily generate reports on workforce demographics or payroll calculations. Structured data may include defined values that follow a consistent format, often constrained by predefined fields or options. Each data entry may be restricted to a set of possible values, such as numbers, dates, or selected options from a list. This makes structured data highly organized and easy to search, filter, and analyze using databases or spreadsheets. In an HR database, structured data might include defined values like “job title” (e.g., “Manager,” “Engineer”), “department” (e.g., “Finance,” “HR”), or “employment status” (e.g., “Full-Time,” “Part-Time”). These values are fixed, making it easy to sort, group, and analyze data by category.

In some embodiments, the worker data 130 includes unstructured data. Unstructured data may include information that does not have a predefined structure or format, making it more complex to organize, search, and analyze. This type of data may include text, images, audio, video, or documents with varying formats. Unlike structured data, unstructured data may not be stored in a traditional row-and-column format and typically requires advanced processing techniques, such as natural language processing (NLP), natural language utilization (NLU), natural language generation (NLG), generative AI (Gen AI), or other machine learning, to extract meaningful insights. In the context of worker data, unstructured data may include a collection of performance evaluations, emails, and meeting notes. Each document may vary in length, structure, and content, with unique information tailored to individual worker experiences and performance details. Since this data is unstructured, software tools may be utilized to analyze it, such as using NLP or NLU for enterprise utilization to identify patterns in feedback or to conduct sentiment analysis to assess overall worker morale from written comments, NLG to generate summaries of evaluations, or Gen AI to synthesize insights from diverse datasets. Unstructured data may include free text or non-standardized content without predefined values, allowing for more flexibility but making it harder to categorize and analyze systematically. Unstructured data may include open-ended responses, paragraphs of text, or media files that lack consistent structure. In performance evaluations, unstructured data may include free-text comments from supervisors, which allow them to write feedback on a worker's strengths and areas for improvement. This free-form text allows for nuanced, detailed feedback but requires advanced processing techniques like NLP, NLU for enterprise utilization, or Gen AI to analyze for trends or insights. While structured data may use standardized fields with defined values for efficiency, while unstructured data may allow for richer, detailed input through free text, providing depth but requiring advanced techniques for meaningful analysis.

In some embodiments, NLU refers to the application of advanced techniques to process, analyze, and understand unstructured textual or spoken language data, particularly for enterprise or domain-specific purposes. NLU may focus on utilizing language data to drive actionable insights and outcomes tailored to organizational needs. NLU may be employed in conjunctions with various other techniques. For example, NLU may use the output of NLP to generate summaries, and those summaries can then be processed by NLG to produce actionable items. In an HR context, for example, unstructured candidate data, such as interview transcripts, cover letters, or performance evaluations, may be processed using an integrated workflow of NLP, NLU, and NLG to produce actionable recommendations. In such an embodiment, NLP techniques may be employed to analyze the unstructured data to extract key themes, sentiments, and keywords (e.g., NLP may identify that a candidate demonstrates “strong communication skills,” “excellent teamwork,” and “moderate technical expertise”), NLU may then be employed to interpret this extracted data to generate structured summaries that distill the candidate's strengths and areas for improvement (e.g., NLU may summarize the insights as: “The candidate demonstrates strong communication and teamwork skills but lacks advanced technical experience”), and then NLG may be employed to transform these structured insights into actionable recommendations for HR professionals (e.g., NLG might generate recommendations such as: “Provide the candidate with training in advanced technical skills” or “Position this candidate in a client-facing role where communication and collaboration are crucial.” Such a process may leverage advanced language technologies to convert unstructured data into meaningful insights and recommendations, enabling HR professionals to make informed, data-driven decisions efficiently.

In some embodiments, candidate data 132 includes data that is indicative of attributes of candidates 114 who are being considered for potential employment by the organization 116, which may be referred to as “candidate worker attributes”. For example, candidate data 132 may include candidate documents 133, such as candidate records, including resumes, cover letters, interview feedback, assessments, references, or other related documents for one or more of the candidates 114. Candidate data 132 may also include other types of data, such as desired job title or availability, that may not be contained in a document format. A candidate record for a candidate may include a document that contains personal details, contact information, application dates, and position applied for, along with recruitment process stages completed. A resume for a candidate may include a document that provides a concise summary of the candidate's professional qualifications, work history, skills, and education relevant to the job they are applying for. A cover letter may include a document in which a candidate expresses their interest in the position, highlights relevant experience, and explains their motivations for joining the organization. Interview feedback may include notes from interviewers that summarize the candidate's responses, assess their qualifications, and provide impressions on aspects like communication skills, cultural fit, and professional demeanor. Assessments may include results from skill-based tests, personality assessments, or technical evaluations that measure a candidate's suitability for the role. References may include written or verbal feedback from former supervisors, colleagues, or mentors, offering insights into the candidate's past job performance, strengths, and areas for growth.

In some embodiments, candidate data 132 includes structured data. For example, candidate data 132 may include organized and formatted information stored in an applicant tracking system (ATS) where each candidate's record has fields like candidate ID, name, desired job title, application date, status in the hiring process, and source of application. This structured format may enable querying or filtering by specific criteria—such as finding all candidates who applied within a certain timeframe or those with specific qualifications—and allow for easy generation of reports on candidate pipelines or recruitment metrics. Structured data in an ATS might include, for example, predefined values such as “application status” (e.g., “Interviewed,” “Pending Review”), “position applied for” (e.g., “Software Engineer,” “Data Analyst”), or “source” (e.g., “Referral,” “Job Board”).

In some embodiments, candidate data 132 includes unstructured data. For example, unstructured candidate data may include cover letters, interview notes, candidate responses to open-ended questions, and audio or video interview recordings. Each of these documents or files may vary in length, content, and structure, tailored specifically to individual candidates. Since this data is unstructured, HR professionals may use specialized software tools to analyze it, such as using NLP to identify themes in responses or sentiment analysis to gauge candidate enthusiasm or fit. In some embodiments, NLG or Gen AI is applied to produce summaries, actionable insights, or formatted reports from the data analyzed by NLP. For example, after NLP identifies key themes or sentiment, NLG may generate concise summaries of candidate responses, and Gen AI may synthesize detailed insights from multiple candidate datasets, enabling efficient review and comparison.

In some embodiments, a worker cohort profile 134 (also referred to as a “talent profile”) is a representation of attributes (e.g., skills, experiences, and other qualities) of a defined group of workers within a specific role or similar positions across the organization 116 (or other organizations). A worker cohort profile 134 may, for example, be created by aggregating and analyzing worker data 130 such as resumes, performance evaluations, and other employment records. In some embodiments, a worker cohort profile 134 includes a vector representation of worker data 130. For example, a worker cohort profile 134 for a worker cohort (e.g., a worker group/cluster) may include a vector set that includes one or more vectors derived from the content of worker documents 131 associated with workers 110 in the worker cohort, such as resumes, performance evaluations, work product, analytics data, and similar records for one or more of the workers 110 in the worker cohort. Elements within a cohort profile 134 may include numbered attributes such as educational background, years of experience in the field, specific technical skills, and past performance metrics, derived from worker documents 131 such as resumes, performance reviews, and project records for one or more of the workers 110 in the worker cohort. In such an embodiment, each attribute (e.g., Element 101: Years of Relevant Experience, Element 102: Certification in Field-Specific Skill, etc.) is vectorized to transform qualitative and quantitative details into a standardized format. These vectors may collectively create a multidimensional representation of the group's capabilities, enabling objective comparisons between the cohort profile and prospective candidates. By converting attributes into vectors, a cohort profile 134 may better captures the competencies and qualities that represent the cohort, providing a comprehensive benchmark for comparing candidate profiles and making informed hiring or promotion decisions.

In the context of a cohort profile 134 for a nursing position within a healthcare organization, a cohort profile 134 may be based on worker documents 131 or other worker data 130 for existing nursing staff, including resumes, clinical care documentation, training certifications, and patient interaction records. Elements within this profile may include “Element 201: Advanced Cardiac Life Support (ACLS) Certification,” “Element 202: Total Clinical Hours in High-Demand Departments (e.g., ICU, ER),” “Element 203: Patient Care Quality Ratings,” and “Element 204: Compliance Rate with Health and Safety Protocols.” Each element may contribute to a detailed competency profile of successful nurses, emphasizing relevant attributes that ensure high-quality patient care. For instance, a high score in “Element 203” may indicate strong patient interaction skills, which can be important in direct care roles. Such a nursing cohort profile may allow HR personnel and hiring managers to vectorize candidate profiles and assess alignment with established cohort attributes. Candidates demonstrating a strong match across critical vectors, such as certification levels and patient care metrics, may be prioritized for the nursing role, supporting an objective, evidence-based selection process to identify individuals best suited for high-demand positions within the healthcare environment.

In some embodiments, a workforce management plan 136 is a strategic, actionable framework for organization 116 to effectively manage the workforce 108. Such a workforce management plan 136 may include defined strategies for workforce planning (e.g., including succession planning), hiring, promotions, and worker development (e.g., including talent development), derived from data-driven decision-making, such as that described here. In some embodiments, a workforce management plan 136 includes specific strategies for hiring and promotion, addressing both immediate and future workforce requirements. For instance, a hiring component of a workforce management plan 136 may incorporate actionable steps for recruiting temporary nurses in response to seasonal or high-demand periods, including identifying the most qualified candidates for temporary nursing positions based on a comparison to established worker cohort profiles of successful nursing staff. Such an approach may, for example, ensure that the temporary nurses selected for critical units, such as the ICU or emergency department, possess essential attributes like certifications and clinical experience levels comparable to permanent nursing staff. A promotion component of a workforce management plan 136 may outline procedures for evaluating the suitability of current workers for advancement, including identifying the most qualified workers to be moved into an open position. Such an approach may, for example, ensure that promotions are based on relevant competencies, skills, and achievements rather than subjective factors, thereby supporting a fair and merit-based advancement process. Additional elements of a workforce management plan 136 may include succession planning, skills gap analysis, and workforce development initiatives. Succession planning identifies internal talent for future key roles, ensuring continuity and stability in critical positions. Skills gap analysis identifies areas for targeted training, allowing HR to implement development programs that build skills essential for the organization's long-term needs. Workforce retention strategies, such as worker engagement initiatives and structured career development opportunities, may also be included to enhance job satisfaction and reduce turnover. For example, if a healthcare organization anticipates a shortage of nursing staff during flu season, the workforce management plan 136 may include preemptive steps for hiring temporary nurses. Using workforce data 124 (including cohort profiles 134), the plan 136 may specify criteria for temporary hires, such as certifications, years of experience, and prior experience in high-intensity departments. HR personnel may, for example, leverage the plan's guidelines to compare candidates'profiles with those of existing nursing staff to ensure a strong match. Such a workforce management plan 136 may enable a comprehensive, evidence-based approach to workforce planning and management that facilitates proactive staffing, efficient allocation of temporary and permanent resources, and alignment of workforce initiatives with the organization's overarching goals and mission.

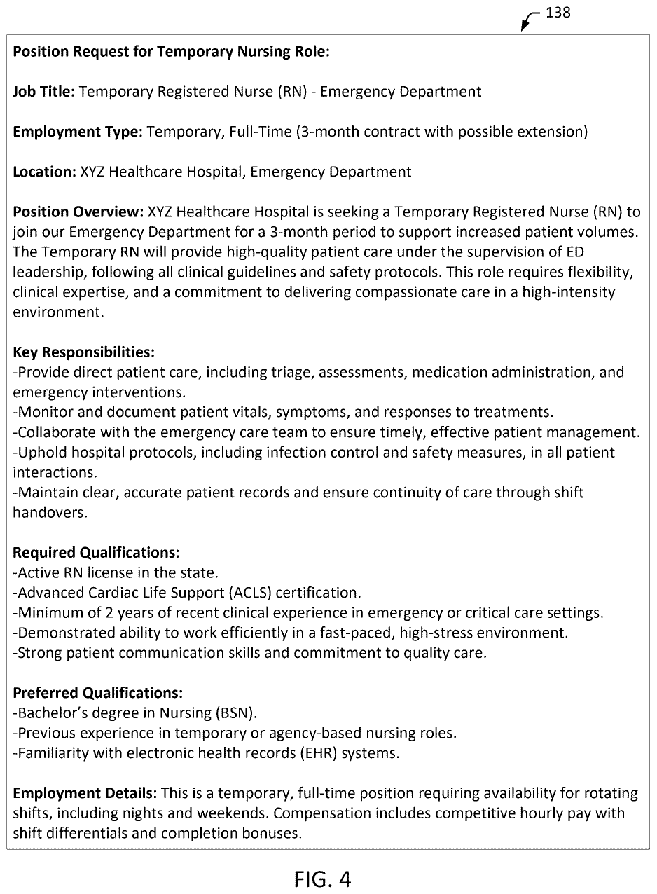

In some embodiments, a position request 138 is a formalized description of an open role within an organization that outlines the responsibilities, qualifications, and other key details required for a specific position. For example, a position request 138 may be a job posting or similar document that communicates job requirements to potential candidates to attract individuals with the skills and experience necessary to meet the organization's needs. In some embodiments, a position request 138 may include essential details for a position (or “job”), such as job title, role description, required qualifications, preferred skills, location, and employment type (e.g., temporary, part-time, or full-time). Additionally, a position request 138 may contain specific attributes and competencies (e.g., derived from worker cohort profiles as described here), to help ensure that candidates align with the established success factors for the role. In the context of hiring temporary nurses for a healthcare organization, a position request 138 may be crafted to meet high-demand staffing needs, such as increased patient volumes during flu season or staffing for critical care units, and may include the job title and employment type, location, position overview, key responsibilities, required qualifications, preferred qualifications, and employment details, outlining the role's scope, required credentials, preferred skills, and specific employment terms. FIG. 4 is a diagram illustrating an example position request 138 in accordance with one or more embodiments. A position request 138 may be published on various platforms, such as a website, an organization's hiring portal, a newspaper, a flyer, or similar media. For example, the position request 138 illustrated in FIG. 4 may be posted on a healthcare staffing agency's website.

In some embodiments, the position request 138 may include a job title that clearly defines the role being filled (e.g., “Temporary Registered Nurse—ICU”) and an employment type that specifies the nature of the position (e.g., full-time, part-time, temporary, contract). The location may specify the physical work location, such as a hospital unit or a facility address. The position overview may provide a concise summary of the role's purpose and high-level responsibilities, giving potential candidates an immediate understanding of the position's relevance and scope. Key responsibilities listed in the position request 138 may outline the main tasks and duties associated with the role. For example, a temporary ICU nurse role might specify responsibilities such as patient monitoring, administering medication, documenting patient records, and collaborating with a healthcare team. Required qualifications may include essential credentials, such as state licensure, years of relevant experience, or certifications (e.g., Advanced Cardiac Life Support (ACLS) certification for critical care roles). Preferred qualifications may include additional skills or experience that enhance a candidate's suitability for the role, such as proficiency in electronic health records (EHR) systems or prior experience in a high-demand environment. Employment details within the position request 138 may describe terms of employment, such as the expected work hours, compensation range, and duration of employment for temporary roles. For example, a temporary nurse role may specify an expected contract period of three months, with availability for night and weekend shifts, and may mention any completion bonuses for fulfilling the contract term. Such detailed information in a position request 138 may provide clarity for potential candidates and help attract individuals who meet the requirements and are committed to the specified work conditions. In some embodiments, a position request 138 may also include information about the application process, such as submission deadlines, required documents (e.g., resume, certifications), and instructions for submitting an application (e.g., “Apply via our online portal by [date]”). This guidance may provide candidates with clear steps to complete their applications, increasing the likelihood of attracting a qualified and well-prepared candidate pool.

The use of position requests 138 as described in various embodiments may enable HR departments and hiring managers to communicate role expectations clearly and consistently. Detailed, standardized position requests 138 may, for example, help attract suitable candidates, facilitate a focused recruitment process, and support the organization's workforce management strategy by aligning new hires with the competencies and qualities needed for organizational success. Once a position request 138 is published, HR personnel or other workforce administrators 106 may monitor incoming applications and initiate candidate assessments based on the criteria outlined in the position request 138. By aligning candidate assessments with the specified qualifications and requirements, workforce administrators 106 may efficiently identify and prioritize applicants who best match the role's needs. In some embodiments, the management system 102 may assist in this process by organizing and filtering applications according to the qualifications and attributes outlined in the position request 138, and by comparing and matching candidates to desired worker attributes using vector-based techniques (such as those described here), thereby streamlining the selection process for hiring managers.

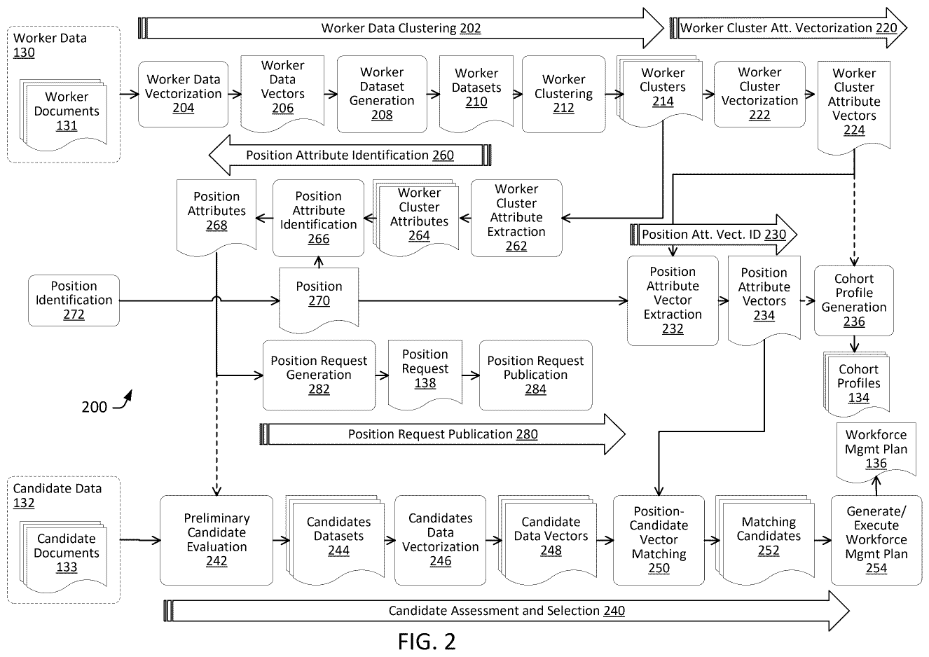

FIG. 2 is a flow diagram illustrating operational aspects of a workforce management system (e.g., a workforce management method) 200 in accordance with one or more embodiments. In the illustrated embodiment, worker data 130 (e.g., including worker documents 131) is processed along a worker data clustering pathway 202 that includes conducting worker data vectorization 204 to generate worker data vectors 206, conducting worker dataset generation 208 to generate worker datasets 210 (e.g., incorporating the worker data vectors 206), and conducting worker clustering 212 to generate worker clusters 214 (e.g., representing defined groupings of cohorts of workers 110 based on the worker datasets 210).

In some embodiments, worker clusters 214 are processed along a worker cluster attribute vectorization pathway 220 that includes conducting worker cluster vectorization 222 to generate worker cluster attribute vectors 224 (e.g., including vector representations of worker clusters 214). The position attribute vector identification pathway 230 may include conducting position attribute vector extraction 232 to generate position attribute vectors 234 (e.g., including attribute vectors that are associated with a given worker position 270). In some embodiments, cohort profile generation 236 is conducted to generate cohort profiles 134 (e.g., including talent profiles including vector representations of attributes for defined groups of workers 110, worker positions, or the like).

In some embodiments, candidate data 132 (e.g., including candidate documents 133) is processed along a candidate assessment and selection pathway 240 that includes conducting preliminary candidate evaluation 242 to determine qualified or other potential candidates and associated candidates datasets 244 (e.g., including filtering out unqualified or unlikely to be successful candidates and their associated candidate data 132 from consideration for the given position). This pathway may also include conducting potential candidates data vectorization 246 to generate candidate data vectors 248 (e.g., including vector representations of candidate data sets 244 for the qualified candidates), conducting position-candidate vector matching 250 to identify matching candidates 252 (e.g., including one or more candidates who are qualified for the position and may be offered the position or otherwise further considered for the position), and generating/executing a workforce management plan 254 (e.g., including further evaluating the matching candidate(s) 252 for the position, offering the position to the matching candidate(s) 252, onboarding the matching candidate(s) 252, or the like).

In some embodiments, a position attribute identification pathway 260 includes conducting worker cluster attribute extraction 262 (e.g., based on the worker clusters 214) to generate worker cluster attributes 264 (e.g., including keywords, values, or the like associated with worker clusters and associated positions), and conducting position attribute identification 266 to identify position attributes 268 (e.g., including attributes, such as keywords, values, or the like associated with a position 270 identified in a position identification operation 272, such as HR identifying that the position 270 is open and needs to be filled). In some embodiments, a position request publication pathway 280 includes conducting position request generation 282 to generate a position request 138 (e.g., a job positing for the position 270 that includes position attributes 268, such as keywords, values, or the like associated with a position 270), and conducting position request publication 284 (e.g., to publish the job positing on the organization's website or portal, on a staffing agency's website, or the like).

Such a vector-based workforce management process may provide a structured, efficient approach to talent assessment and selection. By transforming employment and candidate data into vector representations, the system enables the creation of detailed cohort and talent profiles, allowing HR to evaluate worker and candidate worker attributes comprehensively. This approach may highlight relevant skills and qualifications, minimizing the potential influence of less relevant attributes. Additionally, the process supports automated job posting generation based on identified position attributes, streamlining recruitment and ensuring consistency in job specifications. Such capabilities may, in turn, enhance alignment of candidates with job requirements, reduce the impact of unintentional bias, and improve overall accuracy in workforce management efforts.

### Obtaining Worker Data 130

In some embodiments, the process begins by obtaining worker data 130, which may include various documents associated with a workforce, such as resumes, performance reviews, and work samples of current workers. This may involve collecting and preparing this data as input for further analysis. In the context of hiring temporary nurses, worker data may include certifications, evaluations, and experience records relevant to nursing, which can form a foundational dataset for understanding existing worker capabilities. For example, obtaining worker data 130 may include the workforce management engine 120 identifying currently employed workers 110, such as nurse-type workers (referred to here simply as “nurses”) 110a and 110b currently employed at a hospital-type organization 116, and extracting, from workforce data 124, worker documents 131 that include resumes, performance evaluations (e.g., annual reviews), work product (e.g., patient care reports), and analytics data (e.g., key performance indicators for hours worked or the like) for the nurses 110.

In some embodiments, obtaining worker data 130 includes employing machine learning techniques to standardize and preprocess worker data to prepare it for subsequent analysis. For example, obtaining worker data 130 may include the workforce management engine 120 preprocessing the raw worker data 130 (including worker documents 131) to generate preprocessed data that has content and format suitable for subsequent analysis in the process flow. This may include conducting one or more NLP, NLU, NLG, or the like techniques for text processing and transformation, such as tokenization, embedding generation, and text normalization to convert raw text into structured data. One or more such machine learning techniques may be used in data preprocessing to, for example, help convert unstructured textual data into structured, standardized numerical data, allowing subsequent processes in the workflow to analyze and compare worker profiles effectively. For the hiring of temporary nurses, the resulting standardized, vectorized representations may, for example, enable accurate comparisons across skills, certifications, and experience levels, ensuring that essential qualifications are consistently captured across all worker profiles.

In some embodiments, tokenization includes a process of breaking down text into smaller units, typically words or phrases, that are easier to process. In NLP, tokenization may, for example, involve splitting a resume into individual words, phrases, sentences, or paragraphs. For example, in a nurse's resume, phrases like “ICU experience,” “trauma certification,” and “emergency care” could be tokenized to create distinct data units. Machine learning tokenizers employed by models like BERT or spaCy can, for example, help standardize terminology by converting each word or phrase into tokens, allowing consistent interpretation of terms like “RN” (Registered Nurse) across various documents.

In some embodiments, once tokenized, machine learning models transform tokens into numerical embeddings, capturing the semantic meaning of each word, phrase, sentence, or paragraph. Embedding models such as Word2Vec, GloVe, On-Hot, or BERT can represent each token as a high-dimensional vector, encoding information about its meaning and context. For example, in a trauma nurse's resume, such an embedding model can be employed to generate embeddings for terms like “trauma” and “ICU” that are placed close together in vector space if they frequently appear in similar contexts, reflecting their relevance to each other. Embeddings may, for example, allow the system to capture subtle distinctions, such as the difference between general nursing experience and specialized trauma or ICU experience, providing a more comprehensive representation of each worker's qualifications.

In some embodiments, preprocessing steps include text normalization to standardize and clean text data, preparing it for further analysis. This may include, for example, lowercasing, removing stop words (e.g., “and,” “the”), expanding acronyms, or the like. For example, acronyms like “BLS” (Basic Life Support) or “ACLS” (Advanced Cardiovascular Life Support) in a nurse's profile can be expanded and standardized to ensure that all relevant terms are uniformly recognized. Machine learning models trained on industry-specific terminology, such as healthcare or nursing specific terminology, can be employed to assist in identifying these key terms and expanding them accurately, reducing potential inconsistencies in the dataset.

### Conducting Worker Data Vectorization 204

In some embodiments, conducting worker data vectorization 204 involves transforming the worker documents obtained in the prior step into numerical vectors. These vectors may serve as quantitative representations of the documents themselves rather than summarizing entire worker profiles. Such an approach may allow the system to capture the nuances of each document individually, such as a resume, certification, or performance review, by encoding its content into a vector that can later be combined to form a comprehensive view of the worker's qualifications. In some embodiments, document-level vectorization techniques are applied, focusing on the unique information contained in each document associated with a corresponding worker. For example, a nurse's resume, certification records, and performance evaluations may each be transformed into separate vectors, with each vector reflecting the specific content and context of the document. In such document vectorization, each document may undergo its respective vectorization process, resulting in a unique document vector set that includes one or more vectors that encapsulate the document's content, emphasis, and context. As described, these individual document vectors 206 may then be used, for example, as inputs for the next step, worker dataset generation 208, where they are combined to create a complete dataset representing worker qualifications. By maintaining the specificity of each document at this stage, the system ensures that important details from each document contribute to a worker's overall profile when datasets are aggregated. For example, in the context of nursing, the process may support a highly detailed and accurate representation of each nurse's skills, certifications, and performance history.

In some embodiments, document vectorization is accomplished using machine learning techniques. Document vectorization may, for example, include employing embedding models for document vectorization. For example, advanced embedding models like fine-tuned large language models (FTLLM) and Doc2Vec can generate vectors that capture the semantic meaning of each document. For instance, FTLLM can be fine-tuned to read each document, generating a unique embedding that reflects its key content. If a certification document includes terms like “Advanced Trauma Life Support” or “ICU management,” FTLLM's embeddings may place emphasis on these terms, creating a vector that represents the document's focus on trauma care and critical care skills. FTLLM may also be used to capture meaning at the sentence or paragraph level, providing finer granularity. Such FTLLMs may leverage a transformer-based architecture that can be fine-tuned on specific tasks or datasets, such as the described document vectorization. FTLLMs may be capable of generating embeddings that capture the semantic meaning of text and be particularly effective for tasks involving contextual understanding, as described.

Document vectorization may, for example, include employing TF-IDF and bag-of-words. For example, for certain types of documents, simpler methods like TF-IDF (Term Frequency-Inverse Document Frequency) or bag-of-words can be effective. TF-IDF may be used to highlight terms that are significant within a document but less common across other documents in the dataset, allowing the system to detect specialized language or key phrases that distinguish one document from another. For example, a performance review document might have high TF-IDF values for phrases like “leadership in emergency response” or “exceptional patient care,” emphasizing qualities pertinent to temporary trauma nurse roles.

Document vectorization may, for example, include employing contextual embeddings and document-specific details. Embedding models may be employed to capture contextual relationships within a document by analyzing word order and co-occurrence. For example, in a trauma nurse's performance review, the co-occurrence of terms like “team leader,” “emergency response,” and “trauma unit” within a single document can influence the document vector, signaling strong alignment with emergency and trauma responsibilities. This may allow each document vector to encode specific contextual nuances, making it easier to distinguish between documents emphasizing different skill sets.

Document vectorization may, for example, include hierarchical embedding models. For example, for documents with structured sections (e.g., a resume with sections on “Experience,” “Education,” and “Certifications”), hierarchical embedding models may be used. These models generate embeddings at multiple levels—such as sentence, paragraph, and document—creating a layered representation of content. For instance, a trauma nurse's resume might have separate vectors for sections on ICU experience, certifications, and recent employment history, which are then combined to generate an overarching document vector.

In some embodiments, once vectorized, each document (such as resumes, certifications, or reviews) is represented by a unique vector that reflects its individual content. For instance, in the context of hiring temporary nurses, the documents considered might include resumes, certifications, and performance reviews for various nurses 110, such as nurses 110a and 110b. For a resume that provides an overview of a nurse's experience, skills, and educational background, techniques like sentence-BERT may be applied to each section (e.g., work experience, certifications, etc.) to generate vectors that capture nuanced details such as ICU experience, trauma care skills, and relevant training programs. The resume vector for the resume document might emphasize terms like “emergency response,” “trauma care,” and “critical care.” A certification document that highlights a nurse's specialized training or qualifications, such as “Advanced Trauma Life Support (ATLS)” or “Pediatric Advanced Life Support (PALS),” may be processed using TF-IDF to emphasize unique phrases associated with specialized skills. For example, the resulting certification vector for a certification document might heavily weight terms like “trauma,” “life support,” or “ICU,” which may reflect the certification's emphasis on trauma and emergency skills. A performance review offering insights into a nurse's real-world application of skills, including qualities like leadership in emergency settings or patient care efficiency, may be processed using Doc2Vec or BERT to capture contextual details and sentiments, translating these aspects into a vector representation. A performance review vector might reflect terms like “emergency team leader,” “quick decision-making,” and “trauma unit,” capturing a nurse's performance attributes specific to trauma settings.

### Conducting Worker Dataset Generation 208

In some embodiments, worker dataset generation 208 includes organizing the worker data vectors 206 generated in the previous step and organizing them into structured datasets for each individual worker, resulting in individual worker datasets 210. For example, worker dataset generation 208 may include for each of nurses 110a and 110b, generating a respective worker dataset 210 that includes a worker vector set for the nurse that includes one or more of the vectors sets for documents 131 associated with the nurse (e.g., the vector sets generated for the resumes, certifications, or performance reviews associated with the nurse), along with a position label that identifies the position of the nurse (e.g., trauma nurse). In some embodiments, a position label is generated based on manual labeling. For example, labeling of the worker's position as a “trauma nurse” may be based on a workforce administrator 106 labeling both of nurses 110a and 110b as a “trauma nurse”). In some embodiments, a position label is generated based on label extraction. For example, labeling the position of the nurse 110a as “trauma nurse” may be based on workforce management engine 120 conducting NLP processing to extract the position as a “trauma nurse” from the worker documents 131 associated with the nurse 110a. Embodiments may include any suitable labels for assessing candidates for inclusion in a cohort group, such as a cluster of workers. For example, a worker dataset 210 for a worker may include a performance label that indicates a level of performance by the worker (e.g., a score of 1-10, with 10 indicating a highest level of performance). Such a label may enable filtering and generation of clusters on various attributes. For example, clusters of high performing workers for various positions may include adding to a cluster for a position, only worker dataset 210 having a position label that corresponds to the position and a performance label that indicates a relatively high level of performance (e.g., a score of greater than 5, a label of “high performance,” or the like).

In some embodiments, machine learning techniques are employed to enhance the process of organizing worker data vectors 206 into structured datasets 210 for individual workers. These techniques can be applied to manage, interpret, and label each worker's documents or other data in ways that provide a comprehensive representation of their qualifications, skills, and job roles. In some embodiments, each worker's associated documents, such as resumes, certifications, and performance reviews for the worker, are represented by separate vectors generated in the previous step. To organize these vectors into cohesive datasets, clustering algorithms or dimensionality reduction techniques are employed to group similar document vectors within the dataset, making it easier to highlight related skills or qualifications. For example, for nurses 110a and 110b, clustering algorithms like K-means can be used to group document vectors that are closely related in terms of their content, such as trauma care certifications or emergency room experience. The resulting worker datasets 210 for each nurse might have separate clusters within the dataset representing trauma certifications, performance in critical care, or specialized training, providing a structured, organized view of each nurse's qualifications.

In some embodiments, where a position label (e.g., “trauma nurse”) is assigned to worker datasets to indicate the associated worker's role, machine learning techniques can be employed to support manual labeling or label extraction based on the information contained in the documents.

For example, manual labeling may include, in cases where a workforce administrator 106 manually assigns a position label, using supervised learning models to help predict labels based on historical data or assist the administrator by suggesting likely labels. For example, if most nurses with certain certifications or experience have been labeled “trauma nurse” in previous datasets, a supervised model trained on labeled data could suggest “trauma nurse” for nurses 110a and 110b based on similar characteristics. Automatic label extraction via NLP, for example, may include NLP models, such as Named Entity Recognition (NER) and text classification models, analyzing document content to identify relevant job roles or titles. In the case of nurse 110a, the workforce management engine 120 might use an NER model to recognize terms like “trauma unit” or “emergency care” in the worker documents 131, tagging these as indicators that the worker's role is a “trauma nurse,” and, in turn, labeling the nurse 110a as a “trauma nurse.” In such embodiments, text classification models may be employed to confirm labels by analyzing the frequency and context of trauma-related terms across the documents 131 associated with the nurses 110a or 110b. NER may include, for example, use of rules-based approaches (e.g., relying on predefined patterns or dictionaries to identify entities), machine learning-based approaches (e.g., conditional random fields (CRF) or hidden markov models (HMM), which may treat NER as a sequence-labeling problem, tagging each word in a sequence based on context and learned probabilities), deep learning models (e.g., recurrent neural networks (RNNs), long short-term memory (LSTM) networks, bidirectional LSTM-CRF models, and transformer-based models like BERT, which may operate to capture contextual relationships between words), or transfer learning approaches (e.g., transformer-based models (such as BERT, ROBERTa, and GPT) pre-trained on large text corpora that may be fine-tuned for specific NER tasks, which may generalize well across different domains and can recognize complex entity patterns with minimal additional training data).

In some embodiments, once document vectors are aggregated and a position label is assigned, hierarchical embedding models can be employed to further organize the dataset for each worker. Such models may generate embeddings at multiple levels, such as document-level and section-level, creating a structured dataset that represents the worker's complete profile. For example, for nurses 110a and 110b, a hierarchical model might organize each of their worker datasets 210 by creating vectors that represent experience (e.g., from resumes), qualifications (e.g., from certifications), and performance metrics (e.g., from reviews), all under the “trauma nurse” label. In such an example, worker dataset generation 208 would proceed by taking the worker data vectors 206 generated for each document 131 associated with nurses 110a and 110b and organizing them into structured worker datasets 210 where, for each nurse, vectors representing resumes, certifications, and reviews would be clustered to emphasize relevant trauma care experience, and position labels, either manually assigned by a workforce administrator 106 or automatically generated, would indicate their role as “trauma nurse.” In such an embodiment, the generated worker dataset 210 for each nurse 110 would include structured document vectors and a defined position label, allowing subsequent steps to assess and compare candidates based on their specific qualifications and roles.

### Conducting Worker Clustering 212

In some embodiments, worker clustering 212 uses the worker datasets 210 from the previous step to group similar worker profiles into worker clusters 214. This may include employing clustering algorithms such as K-means, DBSCAN, or hierarchical clustering to organize workers (and associated datasets) based on shared attributes, like position, skillsets and experience levels. For instance, in hiring temporary nurses, clustering could identify a group of trauma nurses, a group of ICU nurses, or the like.

In some embodiments, clustering algorithms such as K-means are employed to automatically group workers based on vector similarities, identifying distinct patterns within the data. Such a process may begin by taking each worker's dataset, including the vectors representing their documents, and assessing similarities among workers'vectors. By examining patterns across these vectors, K-means can detect clusters of workers who share common qualifications, experience, or skills. For example, nurses with specialized trauma care certifications and ICU experience may be grouped into a distinct cluster, separate from nurses with more general experience in non-critical care roles.

In the context of temporary nursing roles, clustering algorithms may organize nurses into groups based on attributes derived from vectorized document data. This may include vectorization of position-related attributes. For example, suppose each nurse's dataset includes vectors generated from resumes, certifications, and performance reviews. These vectors capture specific attributes such as “trauma care,” “ICU experience,” “patient management,” and “emergency response.” Using these document vectors, a trauma nurse might have a high-dimensional vector with strong emphasis on trauma-related terms, while a general practice nurse's vector might emphasize broader terms related to outpatient care or general patient services. The clustering may include grouping by position-related attributes. For example, K-means clustering can be used to group these nurses based on the vector attributes that are most similar among them. Nurses whose document vectors highlight trauma-related terms like “Advanced Trauma Life Support (ATLS)” and “Critical Care” might be grouped into a trauma nurse cluster, while those with vectors emphasizing terms like “primary care” or “community health” may be grouped into a general practice cluster. Such a clustering approach may create groups that reflect each nurse's unique qualifications and experience, making it easier for HR to target specific groups for specialized roles. For example, suppose there are two main clusters—one for trauma nurses and another for general practice nurses. Nurse 110a, with document vectors that strongly represent ICU and trauma care attributes, may be placed in the trauma nurse cluster, along with other nurses who have similar vectors. Meanwhile, nurse 110b, whose document vectors reflect broader nursing experience in outpatient settings, may be placed in the general practice nurse cluster. Each cluster thus represents a distinct cohort of nurses with shared skills and certifications, simplifying the identification of candidates for specific temporary assignments, such as filling urgent trauma or emergency care positions. By using K-means clustering, the system may automatically separate workers into meaningful groups based on their vectorized attributes, helping workforce managers quickly identify suitable candidates for roles that align with their unique qualifications. This structured grouping supports more targeted recruitment and allocation efforts, particularly when filling specialized temporary roles such as trauma and ICU nursing positions.

### Worker Cluster Vectorization 222

In some embodiments, worker cluster vectorization 222 involves generating worker cluster attribute vectors 224 that represent shared characteristics of each worker cluster 214. This process may, for example, translate the collective attributes of a group of workers into one or more vectors that provide a summary of the cluster's primary skills, experience, qualifications, or similar attributes. Such attribute vectors may serve as a higher-level representation of the group, making it easier to analyze and compare clusters with other groups or position requirements. For example, in the context of a temporary nursing role, a trauma nurse cluster created in the previous step might have cluster attribute vectors highlighting “ICU experience,” “Advanced Trauma Life Support (ATLS),” and “critical care certifications.” These attribute vectors help capture the expertise common to the trauma nurse group, enabling HR managers to easily identify cohorts that align with specific job requirements.

In some embodiments, machine learning techniques such as centroid vector calculation or average vector aggregation can be used to create a single attribute vector representing the center of attribute in a cluster or the center of attributes in the cluster itself. For instance, if the trauma nurse cluster includes nurses with strong trauma and ICU backgrounds, the centroid vector may emphasize those key attributes, distinguishing the cluster from others, such as a general practice nurse cluster. Such a clustering approach may help to ensure that each group's collective expertise is encapsulated in one or more concise vectors, aiding in efficient matching with available roles.

### Conducting Position Attribute Vector Extraction 232

In some embodiments, position attribute vector extraction 232 generates position attribute vectors 234 by analyzing position requirements to extract relevant attributes for a specific job role, such as “trauma nurse.” These position vectors may, for example, capture essential skills and qualifications needed for a role and translate them into numerical vectors to facilitate comparison with worker cluster attributes or candidate vectors. For example, a trauma nurse position might require certifications like ATLS, ICU experience, and proficiency in emergency response protocols. Using NLP-based keyword extraction models such as TF-IDF or TextRank, the system may identify these terms from job descriptions or predefined position requirements and convert them into position vectors. These vectors emphasize the qualifications that define the trauma nurse role, making it easier to align candidates with the position. In some embodiments, NER can also be applied to identify specific job-related terms from position descriptions, for example, helping to ensure that critical requirements like “Advanced Cardiac Life Support (ACLS)” or “emergency room experience” are captured. Such a structured vector representation may allow the system to compare candidate qualifications with role requirements accurately.

### Conducting Cohort Profile Generation 236

In some embodiments, cohort profile generation 236 involves generating cohort profiles 134 that include talent profiles representing the shared attributes of defined worker groups, such as those in similar roles or departments. By aggregating worker cluster attribute vectors 224, cohort profiles provide a holistic view of the skill sets and qualifications typical of a specific group, aiding in workforce planning and candidate assessment. For example, in the case of an ICU nurse cohort, a cohort profile may include vectors representing certifications in critical care, years of ICU experience, and specialized trauma training. This cohort profile can serve as a benchmark for evaluating prospective candidates, ensuring that new hires possess attributes comparable to those of successful workers in the cohort. In some embodiments, machine learning models, such as autoencoders or dimensionality reduction techniques, can be used to distill complex information from multiple vectors into a compact cohort profile. These models may, for example, capture the most relevant attributes, enabling HR to quickly assess if a candidate's profile aligns with established team standards.

### Obtaining Candidate Data 132

In some embodiments, obtaining candidate data 132 involves collecting and preparing information related to candidates 114 who are being considered for potential employment. Similar to obtaining worker data 130, this step may include gathering a variety of documents and data points that reflect each candidate's skills, experience, and qualifications. Such data may serve as a foundation for further analysis, vectorization, and comparison with position requirements in subsequent steps. For example, obtaining candidate data 132 may include the workforce management engine 120 identifying a pool of candidates 112, such as nurse candidates (or “nurses”) 114a, 114b, 114c that have applied for employment as a temporary nurse at a hospital organization 116 (e.g., by way of responding to a temporary nurse position request), and extracting, from workforce data 124, candidate documents 133 that include resumes, performance evaluations (e.g., annual reviews), certifications, cover letters, and interview feedback for the candidate nurses 114a, 114b and 114c. These documents may provide a comprehensive view of each candidate's background, including qualifications such as trauma care certifications, ICU experience, and specialized skills relevant to the role.

In some embodiments, obtaining candidate data 132 includes employing machine learning techniques to standardize and preprocess candidate data to prepare it for subsequent analysis. For example, obtaining candidate data 132 may include the workforce management engine 120 preprocessing the raw candidate data 132 (including candidate documents 133) to generate preprocessed data that has content and format suitable for subsequent analysis in the process flow. This may include conducting one or more NLP techniques for text processing and transformation, such as tokenization, embedding generation, and text normalization to convert raw text into structured data. These may include processes like those described with regard to obtaining worker data 130. One or more such machine learning techniques may be used in data preprocessing to, for example, help convert unstructured textual data into structured, standardized numerical data, allowing subsequent processes in the workflow to analyze and compare worker profiles effectively. For the hiring of temporary nurses, the resulting standardized, vectorized representations may, for example, enable accurate comparisons across skills, certifications, and experience levels, ensuring that essential qualifications are consistently captured across all worker profiles.

### Conducting Preliminary Candidate Evaluation 242

In some embodiments, preliminary candidate evaluation 242 involves filtering candidate data 132 to identify individuals who meet at least minimum qualifications for a role. This step involves creating a candidates dataset 244 (including datasets for candidates likely to succeed in the associated position) by excluding candidates unlikely to succeed, such as those lacking essential certifications or experience levels. For instance, in the context of hiring temporary trauma nurses, this step may involve screening for qualifications like ICU experience or ATLS certification, filtering out candidates who lack these prerequisites. Classification algorithms like support vector machines (SVM) or decision trees can be used to identify candidates who meet basic requirements based on their document vectors, enabling the system to shortlist qualified candidates efficiently. Such a preliminary evaluation may reduce the number of candidates and associated data that is subject to further processing, which can, for example, reduce processing overhead and memory requirements, and increase processing speed and efficiency.

In some embodiments, machine learning techniques can be employed to help ensure consistent and unbiased filtering, resulting in a candidates dataset 244 that includes datasets for only those candidates who are most likely to be a strong fit for the position. Machine learning models may, for example, analyze candidate worker attributes, such as experience and certifications, and apply consistent criteria to determine whether a candidate meets minimum qualifications. This may help to reduce subjectivity and ensure that all candidates are evaluated based on objective, data-driven standards.

Different types of machine learning models may be employed to support this process. For example, rules-based filtering techniques and decision trees may involve decision trees that employ a set of rules based on predefined criteria. For example, a decision tree model could evaluate candidates based on rules such as “Has ATLS certification?” or “Has at least two years of ICU experience?” Each criterion may represent a decision node in the tree, leading to an outcome of either “qualified” or “not qualified” based on whether the candidate meets the specific criteria. Such an approach provides a transparent and interpretable evaluation structure, ensuring that all candidates who meet essential requirements are included in the candidates data set 244. In the context of temporary nurse hiring, a decision tree might first check if candidates have the required certifications, such as ATLS (Advanced Trauma Life Support) or ACLS (Advanced Cardiovascular Life Support). The next nodes might check for minimum ICU or trauma care experience. If a candidate meets all nodes'requirements, they may be classified as “qualified.” If any requirement is not met, the candidate may be classified as “not qualified” and filtered out of the candidates dataset 244.

In some embodiments, fine-tuned large language models (FTLLMs) can be used to enhance filtering processes by generating questions and answers to further evaluate candidates and identify their qualifications. For instance, predefined prompts can be designed to extract specific qualifications, such as years of experience in trauma care, certifications, or ICU performance scores. In some embodiments, the LLM processes the rules and creates tailored questions like “Describe your experience managing critical trauma cases” or “What certifications have you completed related to ICU management?” The responses can then be analyzed to determine whether candidates meet the defined criteria, enabling pre-filtering based on semantic understanding. This may allow for a more dynamic and nuanced evaluation of candidate qualifications.

As another example, support vector machines (SVM) may include supervised learning models that are employed to classify candidates by finding an optimal decision boundary based on their qualifications. SVMs may be especially useful when dealing with multidimensional data, as they may be used to separate candidates with similar qualifications by creating a hyperplane that divides “qualified” candidates from “unqualified” ones. Such an approach may be beneficial when evaluating multiple criteria at once, such as years of experience, certifications, and performance scores. For example, suppose the workforce management engine 120 uses an SVM model to assess temporary nurse candidates by analyzing a combination of ATLS certification, years of trauma experience, and prior performance reviews. The SVM model may create a boundary that separates candidates with strong qualifications (e.g., candidates with high trauma care scores and long ICU experience) from those who fall short in one or more areas. Candidates who fall on the “qualified” side of the hyperplane are added to the candidates dataset 244, while others are filtered out. As another example, logistic regression for binary classification may be employed to help classify candidates as “qualified” or “not qualified” based on key attributes by calculating the probability that a candidate meets the role's requirements. Logistic regression may be especially useful in scenarios where a yes-or-no decision needs to be made, and it provides insights into which attributes contribute most significantly to a candidate's likelihood of qualification. In temporary nurse hiring, logistic regression could evaluate candidates based on weighted attributes like trauma experience, ICU shifts completed, and performance ratings. The model might assign higher weights to attributes most critical for the trauma nurse role, such as “experience in trauma care.” Logistic regression may, for example, then output a probability score for each candidate, with candidates scoring above a threshold being classified as “qualified” and added to the candidate dataset 244. As another example, random forests may use an ensemble learning technique combining multiple decision trees to produce a more accurate, stable evaluation. By using many trees, random forests may help account for variability and provide a well-rounded assessment of candidate qualifications. They may, for example, weigh different qualifications dynamically, ensuring that the most relevant attributes for the role (e.g., trauma certification and ICU experience) receive appropriate emphasis. For example, for temporary nurse recruitment, a random forest model may evaluate candidates by considering multiple decision paths based on certifications, years of experience, and skill evaluations. The model may consider candidates with advanced certifications and experience in trauma units more strongly, consistently selecting the best-qualified candidates. This robust method reduces the chance of overlooking candidates who might meet nonstandard but still relevant qualifications for the trauma role.

Use of machine learning models such as decision trees, SVMs, logistic regression, or random forests may help ensure that preliminary candidate evaluation is conducted with consistency and accuracy, filtering out candidates who do not meet minimum qualifications while preserving those who are best suited for the role. Such a data-driven approach may enable HR to assemble a candidates dataset 244 that includes datasets for individuals who are likely to succeed in the associated position, supporting a fair and efficient candidate assessment process for roles like temporary trauma nurse assignments.

### Conducting Potential Candidates Data Vectorization 246

In some embodiments, conducting potential candidates data vectorization 246 involves transforming the candidate datasets 244 for each qualified candidate into candidate data vectors 248. Similar to the worker data vectorization process, this step may involve converting individual documents and data points within each candidate's dataset into numerical vectors that represent the unique qualifications and attributes of the candidate. The result may be a vector set (a “candidate worker vector set”) that includes one or more vectors that, for example, serve as structured representations of each candidate's qualifications, making it possible to compare them accurately with position attribute vectors in the subsequent step of position-candidate vector matching 250. In some embodiments, the vectorization process in this step can apply various machine learning and NLP techniques, for example, focusing on each document or data element in the candidate dataset to ensure a thorough representation of the candidate's skills, experience, and qualifications. In some embodiments, document-level vectorization techniques are employed. Here, for example, each document within the candidate dataset—such as resumes, certifications, performance reviews, and assessments—is vectorized individually, capturing the specific content of each document, which may then be combined into a cohesive candidate vector.

Different types of machine learning models may be employed to support this process. For example, embedding models for document representation may employ advanced embedding models, such as BERT, Doc2Vec, or Sentence-BERT, that are used to generate vectors that capture the semantic meaning of each document. For instance, BERT or Sentence-BERT can create embeddings that highlight key details within the candidate's resume, such as trauma care experience, certifications, or ICU rotations, by focusing on context and word relationships. For example, in the case of a candidate applying for a temporary trauma nurse role, BERT might generate a vector for their resume that emphasizes terms such as “critical care,” “emergency response,” and “trauma team leadership.” Such a vector may reflect the resume's emphasis on trauma-related experience, ensuring the unique aspects of the candidate's qualifications are encoded. As another example, TF-IDF (Term Frequency-Inverse Document Frequency) may be used for key phrase extraction. This may include, for certain documents such as certifications or performance reviews, employing TF-IDF to identify and emphasize key terms that are unique to the candidate's qualifications. TF-IDF may, for example, assign higher weights to terms that appear frequently in a document but are rare in other candidate datasets, highlighting specialized skills or qualifications. For example, if the candidate has a performance review document with phrases like “efficient in emergency care” or “strong patient management skills,” TF-IDF may assign higher weights to these phrases, generating a vector that reflects these essential skills. Such a vectorization may highlight unique strengths that can distinguish the candidate from others. As another example, hierarchical embedding models may be employed. For example, when a candidate's resume or profile contains structured sections (e.g., “Experience,” “Certifications,” “Skills”), hierarchical embedding models can be applied to create vectors at multiple levels—such as section, paragraph, and sentence—before combining them into a comprehensive document vector. For example, for a candidate's resume with distinct sections, a hierarchical embedding model might generate separate vectors for each section: one for “Experience” focusing on trauma unit rotations, one for “Certifications” with ATLS and ACLS credentials, and one for “Skills” with specific ICU competencies. These vectors may, for example, then be aggregated to produce a complete document vector representing the entire resume's content.

The following includes examples of candidate data vectorization for temporary trauma nurse position candidates. Consider a candidate dataset for a nurse applying for a temporary trauma role, with the dataset including three main documents: a resume, a trauma care certification, and a performance review. In a resume vectorization process, the candidate's resume may list ICU experience, trauma care skills, and certifications in advanced life support, and, using BERT or Sentence-BERT, a vector is generated that captures these qualifications in detail. Such a vector may emphasize terms like “ICU,” “trauma,” and “emergency procedures,” reflecting the candidate's suitability for critical care roles. In a certification vectorization process, the candidate's ATLS certification document may highlight their trauma life support skills, and TF-IDF may be applied to assign higher weights to critical terms such as “Advanced Trauma Life Support” and “critical patient care.” This may, for example, generate a certification vector that showcases the candidate's trauma specialization, ensuring these attributes are easily identifiable in vector comparisons. In a performance review vectorization process, the performance review may highlight feedback from supervisors, noting the candidate's efficiency under pressure and teamwork in emergency settings, and Doc2Vec, BERT, or the like may be used to capture sentiments and key terms like “efficient in trauma settings” and “collaborative in ICU.” Such a review vector may emphasize soft skills and performance in high-stress environments. Once vectorized, these individual document vectors may be combined into a cohesive candidate data vector 248, which represents the full range of the candidate's qualifications. Such a candidate data vector may, for example, be ready for use in subsequent position-candidate vector matching (e.g., at block 250), where it can be accurately compared with position attribute vectors. This process may help to ensure that the candidate's unique skills and experience, as reflected in each document, are encoded in a standardized format, allowing for precise alignment with role-specific requirements in the next step.

### Conducting Position-Candidate Vector Matching 250

In some embodiments, conducting position-candidate vector matching 250 involves comparing candidate data vectors 248 generated in the previous step with position attribute vectors 234 to assess candidate alignment with an associated position. This step may, for example, evaluate the degree of alignment between each candidate's qualifications and the requirements of the position, enabling the system to identify one or more matching candidates 252 who meet or exceed the role's criteria.

In some embodiments, machine learning techniques, such as cosine similarity or nearest neighbor algorithms, can be employed to determine how closely a candidate's vector aligns with the position attribute vector. Cosine similarity may, for example, measure the angle between two vectors, producing a similarity score that indicates how well a candidate's attributes match the role requirements. K-Nearest Neighbors (KNN) may, for example, rank candidates based on proximity to the position vector, allowing the system to identify candidates who are most similar to the ideal qualifications. For example, in the context of temporary trauma nurses and assessing candidates for a trauma nurse role, cosine similarity might compare candidate vectors emphasizing “ICU experience,” “trauma certification,” and “emergency response” with the position vector for a trauma nurse position. One or more candidates whose vectors align most closely with these terms would receive the highest similarity scores, and those candidates would be designated as matching candidates 252. As described, a matching candidate may, for example, move forward in the hiring/placement process for final consideration.

### Generating/executing a Workforce Management Plan 254

In some embodiments, generating or executing a workforce management plan 254 involves using the one or more matching candidates 252 identified in the previous step to create a structured plan for hiring, onboarding, or further evaluating candidates. This plan may, for example, outline next steps based on organizational needs, ensuring that hiring processes are aligned with role requirements and broader workforce goals.

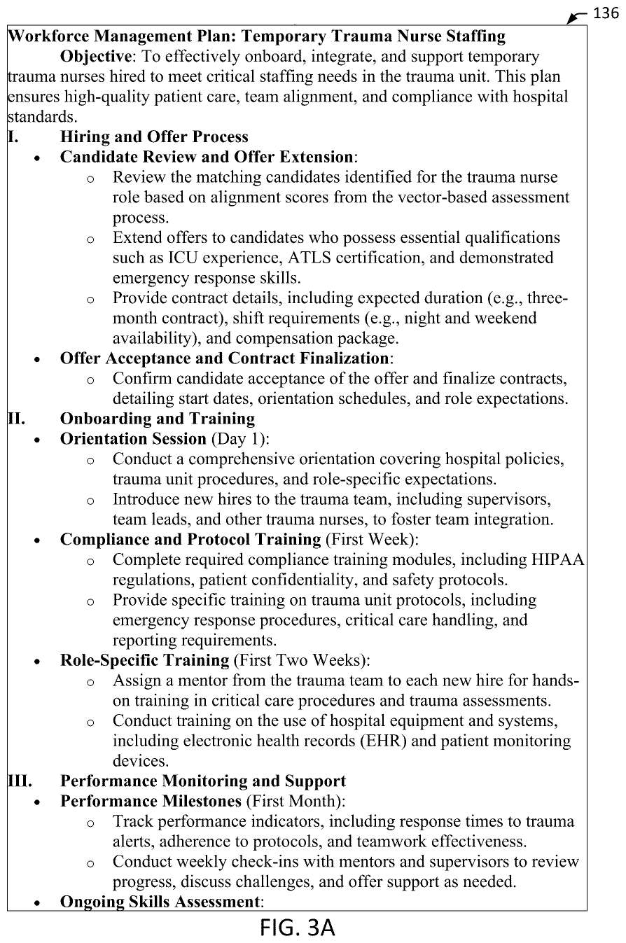

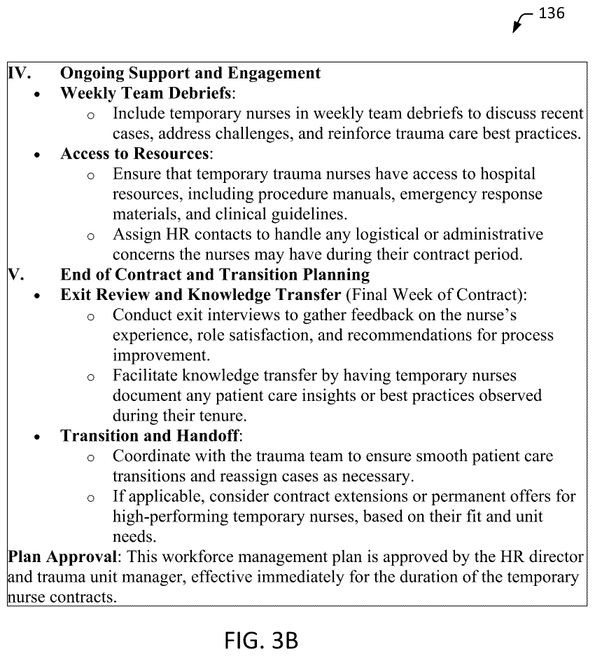

In some embodiments, machine learning techniques, such as reinforcement learning algorithms, can be used to optimize this plan by dynamically adjusting candidate priorities based on past hiring outcomes. For example, the system may prioritize candidates with attributes historically associated with successful hires for similar positions, improving hiring efficiency over time. For example, in the context of temporary nurses, if the system identifies trauma nurses with high alignment to role requirements, the workforce management plan may prioritize these candidates for immediate onboarding. Such a plan may also specify training and orientation steps tailored to ICU protocols and emergency care. Reinforcement learning could, for example, refine the plan by identifying patterns in successful hires, such as placing extra emphasis on certifications, to prioritize candidates who best match past successful hires. FIGS. 3A and 3B are diagrams illustrating an example workforce management plan 254 in accordance with one or more embodiments. Such a workforce management plan may provide a structured, phased approach to hiring, onboarding, and supporting temporary trauma nurses, ensuring that they are well-prepared to contribute effectively to the trauma unit and that their integration is smooth and aligned with hospital goals.

### Conducting Worker Cluster Attribute Extraction 262

In some embodiments, conducting worker cluster attribute extraction 262 involves analyzing worker clusters 214 to extract common attributes, thereby generating worker cluster attributes 264. These attributes may include keywords or other values that capture the defining characteristics of each cluster, making it easier to understand shared skills, experience levels, or qualifications.

In some embodiments, machine learning techniques, such as topic modeling algorithms like latent Dirichlet allocation (LDA) or non-negative matrix factorization (NMF), can be employed to identify prevalent terms within each cluster, summarizing key competencies. For instance, in a trauma nurse cluster, common terms might include “emergency care,” “trauma certification,” and “critical patient management.” For example, in the context of trauma nurses, by analyzing the trauma nurse cluster, the system might extract attributes like “Advanced Trauma Life Support (ATLS),” “ICU rotations,” and “high-stress response.” These extracted attributes may, for example, become part of the worker cluster attributes 264, which can then inform future job matching and cohort profile creation. Such a step may ensure that each cluster's essential attributes are documented, helping HR understand the strengths and qualifications typical of each group.

### Conducting Position Attribute Identification 266

In some embodiments, conducting position attribute identification 266 uses worker cluster attributes 264 to define specific position attributes 268 for a role, such as a trauma nurse. This step may include identifying skills, qualifications, or experience levels that are critical to the role, creating a structured list of requirements for candidate assessment. In some embodiments, machine learning techniques, such as NLP (like NER) or text classification models, are employed to analyze terms in worker clusters to identify critical position attributes. For example, NER might be used to detect keywords like “ICU experience” and “ATLS certification” in a trauma nurse cluster, classifying them as essential position attributes. For example, in the context of temporary trauma nurses, where an open trauma nurse position is identified by HR in a position identification operation 272, position attribute identification 266 may analyze similar roles in worker clusters to define specific requirements, such as “Advanced Cardiac Life Support (ACLS)” and “emergency care experience,” as position attributes 268. Such a process may ensure that the job description accurately reflects essential qualifications.

### Conducting Position Request Generation 282

In some embodiments, conducting position request generation 282 includes creating a position request 138 by compiling identified position attributes 268 into a formal job posting. Such a posting may communicate essential role requirements, responsibilities, and qualifications to attract qualified candidates.

In some embodiments, machine learning techniques, such as NLP/NLU/NLG-based text generation models (e.g., GPT-3), are employed to assist in drafting these postings, generating clear, professional job descriptions. Such models may analyze position attributes derived from previous steps, ensuring that key qualifications are included and that job descriptions are consistently formatted and comprehensive. For arriving at role requirements, for example, machine learning models use entity recognition and classification techniques to analyze historical job descriptions, worker profiles, and position attributes, identifying common skills, certifications, and experiences that align with high performance in similar roles. For instance, machine learning models may analyze trauma nurse position attributes 268 to determine that “ICU experience” and “ATLS certification” are essential qualifications for a temporary trauma nurse role. For example, for a temporary trauma nurse position, the system may analyze identified position attributes 268 and successful candidate profiles to identify essential skills and qualifications. The generated position request might then include requirements for ICU experience and ATLS certification, as well as a detailed description of duties such as patient monitoring and emergency response. By automating position request generation, the system may help ensure that job postings are accurate, aligned with organizational needs, and effectively highlight qualifications that attract well-suited candidates. FIG. 4 is a diagram that illustrates an example position request 138 in accordance with one or more embodiments. The illustrated position request 138 includes a job posting for a temporary nursing role, outlining various attributes of the job, such as title, employment type, location, position overview, key responsibilities, required qualifications, preferred qualifications, and other details.

### Conducting Position Request Publication 284

In some embodiments, conducting position request publication 284 involves publishing the generated position request 138 to various recruitment platforms, such as the organization's website or job boards. This process may ensure broad visibility for open roles and enable HR to attract a diverse and qualified applicant pool. In some embodiments, automated publishing APIs or the like are employed to expedite this process by distributing the position request to multiple platforms simultaneously. Such an approach may help ensure timely and widespread access to job postings, which is especially valuable for high-demand roles. For example, in the context of temporary nurses for a trauma nurse role, the position request could be posted on healthcare staffing websites, hospital portals, and job boards specialized in nursing roles. Referring to FIG. 4, the position request 138 may be published on various platforms, such as a website, an organization's hiring portal, or similar media. Automated publication may ensure that the job reaches qualified trauma nurses promptly, helping HR fill temporary positions efficiently.

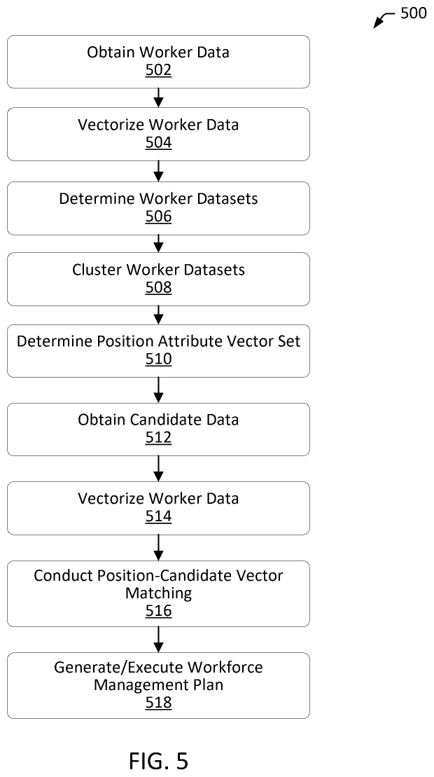

FIG. 5 is a flowchart diagram illustrating a method of workforce management 500 in accordance with one or more embodiments. Some or all of the procedural elements of method 500 may be performed, for example, by workforce management engine 120 or another entity.

Method 500 may include determining worker data (block 502). This may include obtaining worker data that includes documents associated with one or more workers of an organization. For example, determining worker data may include workforce management engine 120 identifying currently employed workers 110, such as nurse type workers (or “nurses”) 110 (including nurses 110a and 110b) currently employed at a hospital type organization 116, and extracting, from workforce data 124, worker documents 131 that include resumes, performance evaluations (e.g., annual reviews), work product (e.g., patient care reports), and analytics data (e.g., key performance indicators for hours worked or the like) for the nurses 110. In some embodiments, determining worker data may include employing processes that are the same or similar to those described with regard to at least the obtaining of worker data 130 of FIG. 2.

Method 500 may include vectorizing worker data (block 504). This may include vectorizing obtained documents associated with one or more workers of an organization, to generate vector representations of the documents. Continuing with the above example, vectorizing worker data may include workforce management engine 120, for each of the worker documents 131 associated with the currently employed nurses 110 (including nurses 110a and 110b) (e.g., for each of the resumes, performance evaluations, work product, and analytics data report documents for the nurses 110) vectorizing the document to generate a vector representation of the document, which may include a vector set that includes one or more vectors that represent the content of the document. In some embodiments, vectorizing worker data may include employing processes that are the same or similar to those described with regard to at least the conducting of worker data vectorization 204 of FIG. 2.

Method 500 may include determining worker datasets (block 506). This may include generating, based on vector representations of documents associated with one or more workers of an organization, labeled worker datasets that include a label (e.g., a position/job label) and an associated vector set for the worker (a “worker vector set”). Continuing with the above example, determining worker datasets may include workforce management engine 120, for each of the nurses 110 (including each of nurses 110a and 110b), identifying documents associated with the nurse 110, generating an worker vector set that includes the vector representations of the documents identified as associated with the nurse 110, determining a position of the nurse (e.g., trauma nurse), and generating a labeled worker dataset for the nurse 110 that includes (a) the worker vector set for the nurse, and a position label corresponding to the determined position of the nurse. In some embodiments, determining worker datasets may include employing processes that are the same or similar to those described with regard to at least the conducting of worker dataset generation 208 of FIG. 2.

Method 500 may include clustering worker datasets (block 508). This may include clustering, based on position labels, labeled worker datasets to determine position clusters. Continuing with the above example, clustering worker datasets may include workforce management engine 120, applying a clustering algorithm to a set of worker datasets, including some or all of the labeled worker datasets for each of the nurses 110 (including each of nurses 110a and 110b), to generate one or more position clusters, where each of the position clusters is associated with a position and includes a set of one more labeled worker datasets having a position label that corresponds to the associated position. For example, a clustering algorithm may generate a “trauma nurse” cluster that includes nurse 110a (e.g., based on nurse 110a having a position label of trauma nurse), a “general practice nurse” cluster that includes nurse 110b (e.g., based on nurse 110b having a position label of general practice nurse), and so forth. In some embodiments, clustering worker datasets may include employing processes that are the same or similar to those described with regard to at least the worker clustering 212 of FIG. 2.

Method 500 may include determining position attribute vector sets (block 510). This may include determining, based on vector sets of labeled worker datasets, an attribute vector set for one or more given positions. This may include a worker cluster vectorization operation, as well as a position attribute vector extraction. Continuing with the above example, determining position attribute vector sets may include the management engine 120, determining, for each of the clusters, generating, based on the vector sets of the labeled worker datasets for the workers in the cluster, an attribute vector set for a position associated with the cluster. For example, a vector aggregation operation may be conducted on all of the vector sets of labeled worker datasets for the workers in the cluster “trauma nurse” (e.g., including the nurse 110a) to generate an attribute vector set for the “trauma nurse” position, a vector aggregation operation may be conducted on all of the vector sets of labeled worker datasets for the workers in the cluster “general practice nurse” (e.g., including the nurse 110b) to generate an attribute vector set for the “general practice nurse” position, and so forth. In some embodiments, determining position attribute vector sets may include employing processes that are the same or similar to those described with regard to at least the worker cluster vectorization 222 or position attribute vector extraction 232 of FIG. 2.

Method 500 may include determining candidate data (block 512). This may include obtaining candidate data that includes documents associated with one or more candidates for employment or the like with an organization. For example, determining candidate data may include the workforce management engine 120 identifying a pool of candidates 112, such as nurse type candidates (or “nurses”) 114 (e.g., including nurses 114a, 114b, and 114c) that have applied for employment as a temporary nurse at the hospital type organization 116 (e.g., by way of responding to a temporary nurse position request, such as that of FIG. 4), and extracting, from workforce data 124, candidate documents 133 that include resumes, performance evaluations (e.g., annual reviews), certifications, cover letters, and interview feedback for the candidate nurses 114. In some embodiments, determining candidate data may include employing processes that are the same or similar to those described with regard to at least the obtaining of candidate data 132 (and preliminary candidate evaluation 242) of FIG. 2.

Method 500 may include vectorizing candidate data (block 514). This may include vectorizing obtained documents associated with one or more candidates, to generate vector representations of the documents, and generating candidate vector sets for the one or more candidates. Continuing with the above example, vectorizing candidate data may include workforce management engine 120, for each of the candidate documents 133 associated with the candidate nurses 114 (including nurses 114a, 114b, and 114c) (e.g., for each of the resumes, performance evaluations, certifications, cover letters, and interview feedback documents for the candidate nurses 114) vectorizing the document to generate a vector representation of the document, which may include a vector set that includes one or more vectors that represent content of the document. For each of the candidate nurses 114, the vector representations of the documents associated with the candidate nurse 114 may be processed to generate a vector set (a “candidate worker vector set”) for the candidate nurse 114 (e.g., including one or more vectors representative of the qualifications of the nurse 114). In some embodiments, the vector set for each candidate nurse 114 may include vectors that correspond to the vectors contained in position attribute vectors for the position to which the candidate is to be matched (e.g., the position to which the nurse is applying). This may enable a simplified comparison between a candidate's vector set and the position attribute vectors for the position to which the candidate is applying. In some embodiments, vectorizing candidate data may include employing processes that are the same or similar to those described with regard to at least the conducting of potential candidates data vectorization 246 of FIG. 2.

Method 500 may include conducting position-candidate vector matching (block 516). This may include comparing a candidate worker's vector sets to an attribute vector set for a given position to determine whether the candidate worker is qualified (or most qualified) for the given position. Continuing with the above example, in a search to fill two trauma nurse positions, position-candidate vector matching may include workforce management engine 120, for each of the candidate nurses 114 (including nurses 114a, 114b, and 114c), comparing the vector set associated with the candidate nurse 114 to the vector set for the “trauma nurse” position, to determine whether the candidate nurse 114 is qualified for the position. This may also include scoring a similarity between the vector set for the candidate nurse 114 to the vector set for the “trauma nurse” position to generate an associated similarity scoring. Such a scoring may be used to determine whether the candidate nurse 114 is qualified for the position (e.g., if the scoring satisfies a threshold similarity score), or how well the candidate nurse 114 is qualified relative to other candidates (e.g., in the case of looking to fill two trauma nurse positions, is the score for the candidate nurse 114 one of the top two scores of the candidates for the trauma nurse position). For example, nurses 114a and 114c may each have a similarity score that satisfies a threshold (where the scores for nurses 114a and 114c are the top two scores out of the candidates nurses 114 considered), and nurse 114b may have a similarity score that does not satisfy the threshold. As a result, nurses 114a and 114c may be determined to be the best two matches for the two “trauma nurse” positions. In some embodiments, position-candidate vector matching may include employing processes that are the same or similar to those described with regard to at least the conducting of position-candidate vector matching 250 of FIG. 2.

Method 500 may include generating and/or executing a workforce management plan (block 518). This may include, in response to determining that the candidate worker is (or is not) qualified for a given position, extending (or not extending) an offer for the given position to the candidate worker. Continuing with the above example concerning a search to fill two trauma nurse positions, generating a workforce management plan may include workforce management engine 120 generating a workforce management plan 136 that instructs extending an offer to nurses 114a and 114c for the two “trauma nurse” positions and outlines procedures and the like for offering and onboarding them. In some embodiments, the workforce management plan 136 is executed to provide for effective workforce management. For example, management engine 120 (or a workforce administrator 106) may initiate extending an offer to nurses 114a and 114c (e.g., sending a request directly to the nurses 114, or to a healthcare staffing agency representing the nurses 114), and may execute some or all of the onboarding procedures outlined in the workforce management plan 136, such as requesting documentation, providing work assignments, providing training, alerting other staff of the new hires, enabling the nurses'access to the healthcare facility, generating a worker identification number, generating worker badges, setting up payroll/benefits enrollment, requesting feedback on the hiring process, or the like. In some embodiments, generating and/or executing a workforce management plan may include employing processes that are the same or similar to those described with regard to at least the generating or executing of a workforce management plan 254 of FIG. 2.

Described techniques provide methods and systems for efficiently managing workforce resources by automating workforce processes such as recruitment, evaluation, onboarding, and employee development through data-driven techniques. Using vectorization and machine learning, the system generates comprehensive profiles for both employees and candidates, allowing workforce management systems and processes to assess qualifications, match candidates with role requirements, and facilitate strategic workforce planning with high accuracy and reduced bias. These capabilities can enhance processing speed and accuracy, streamlining talent management while reducing computational overhead in decision-making processes.

FIG. 6 is a diagram illustrating an example computer system (or “system”) 1000 in accordance with one or more embodiments. The system 1000 may include a memory 1004, a processor 1006, and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., the workforce system 101, the workforce management system 102, workforce management engine 120, the workforce administration 104 (e.g., including workforce administrators 106), the workforce 108 including workers 110 (e.g., including workers 110a and 110b), candidate pool 112, which includes candidate workers 114 (e.g., including candidate workers 114a, 114b, and 114c), the organization 116), operational aspects of environment 100 or workforce management system 102, method 200 or method 500.

The processor 1006 may be any suitable processor capable of executing program instructions. The processor 1006 may include one or more processors that carry out program instructions (e.g., the program instructions of the program modules 1012) to perform the arithmetic, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user-input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors, modules, or applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification, discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such a conflict, the text of the present document governs, and terms in this document should not be given a narrower reading in virtue of the way in which those terms are used in other materials incorporated by reference.

The present techniques will be better understood with reference to the following enumerated embodiments:
1. A method of workforce management, the method comprising:
   obtaining documents associated with workers;
   vectorizing the documents to generate vector representations of the documents, the vectorizing comprising, for each of the documents obtained, generating a vector representation of the document;
   generating, based on the vector representations of the documents, worker vector sets, the generating of the worker vector sets comprising, for each of the workers:
      identifying documents associated with the worker; and
      generating a worker vector set based on the vector representations of the documents identified as associated with the worker;
   generating, based on the worker vector sets, labeled worker datasets comprising position labels, the generation of the labeled worker datasets comprising, for each of the workers:
      determining a position of the worker; and
      generating a labeled worker dataset comprising:
         the vector set for the worker; and
         a position label corresponding to the position of the worker determined;
   clustering, based on the position labels, the labeled worker datasets to determine position clusters, each of the position clusters associated with a position and comprising a set of one more labeled worker datasets comprising a position label that corresponds to the position;
   determining, based on the vector sets of the labeled worker datasets, an attribute vector set for a given position, the attribute vector set for the given position determined based on the worker vectors sets of a position cluster of the position clusters that is associated with the given position;
   obtaining candidate documents associated with a candidate worker;
   vectorizing the candidate documents to generate vector representations of the candidate documents, the vectorizing comprising, for each of the candidate documents, generating a vector representation of the candidate document;
   generating, based on the vector representations of the documents, a candidate worker vector set;
   comparing the candidate worker vector set to the attribute vector set for the given position to determine whether the candidate worker associated with the candidate worker vector set is qualified for the given position; and
   extending, in response to determining that the candidate worker is qualified for the given position, an offer for the given position to the candidate worker.
2. the Method of Embodiment 1,
   wherein the generation of the labeled worker datasets comprises, for each of the workers, determining a performance of the worker, wherein the labeled worker dataset for the worker comprises a performance label corresponding to the performance of the worker, and
   wherein the attribute vector set for a given position is determined based on the vector sets of the labeled worker datasets of a position cluster of the position clusters that are associated with the given position and that have a performance label that is indicative of a relatively high level of performance.
3. The method of embodiment 1 or embodiment 2,
   wherein the attribute vector set for a given position comprises a single vector representation of multiple vectors generated based on the documents associated with workers, and
   wherein the candidate worker vector set comprises a single vector representation of multiple vectors generated based on the candidate documents associated with the candidate worker.
4. The method of any one of embodiments 1-3, further comprising:
   generating, based on the labeled worker datasets of a position cluster associated with the given position, a set of worker attributes for the position;
   generating, based on the set of worker attributes for the position, a worker position request; and
   publishing the worker position request.
5. The method of embodiment 4, wherein the candidate documents associated with the candidate worker are provided in association with the worker position request published.
6. The method of embodiment 4 or embodiment 5, wherein the set of worker attributes for the position comprise keywords or values.
7. The method of any one of embodiments 1-6, further comprising:
   generating, based on the labeled worker datasets of a position cluster associated with the given position, a set of worker attributes for the position;
   identifying, based on the set of worker attributes for the position, a set of potential candidate workers, the set of potential candidate workers including the candidate worker; and
   identifying, from the set of potential candidate workers, the candidate worker for assessment,
   wherein the vectorizing of the candidate documents is performed responsive to selecting the candidate worker for assessment.
8. The method of embodiment 7, wherein set of worker attributes for the position comprise threshold criteria, and wherein the set of potential candidate workers is selected based on comparison of structured data of candidate documents associated with the set of potential candidate workers to the threshold criteria.
9. The method of any one of embodiments 1-8, wherein the documents comprise unstructured text, and the vectorizing comprising, for each of the documents obtained, generating a vector representation of the document based on the unstructured text of the document.
10. a Workforce Management System Comprising:
   a processor; and
   non-transitory computer readable medium comprising program instructions stored thereon that are executable by the processor to perform the following operations for workforce management:
      obtaining documents associated with workers;
      vectorizing the documents to generate vector representations of the documents, the vectorizing comprising, for each of the documents obtained, generating a vector representation of the document;
      generating, based on the vector representations of the documents, worker vector sets, the generating of the worker vector sets comprising, for each of the workers:
         identifying documents associated with the worker; and
         generating a worker vector set based on the vector representations of the documents identified as associated with the worker;
      generating, based on the worker vector sets, labeled worker datasets comprising position labels, the generation of the labeled worker datasets comprising, for each of the workers:
         determining a position of the worker; and
         generating a labeled worker dataset comprising:
         the vector set for the worker; and
         a position label corresponding to the position of the worker determined;
      clustering, based on the position labels, the labeled worker datasets to determine position clusters, each of the position clusters associated with a position and comprising a set of one more labeled worker datasets comprising a position label that corresponds to the position;
      determining, based on the vector sets of the labeled worker datasets, an attribute vector set for a given position, the attribute vector set for the given position determined based on the worker vectors sets of a position cluster of the position clusters that is associated with the given position;
      obtaining candidate documents associated with a candidate worker;
      vectorizing the candidate documents to generate vector representations of the candidate documents, the vectorizing comprising, for each of the candidate documents, generating a vector representation of the candidate document;
      generating, based on the vector representations of the documents, a candidate worker vector set;
      comparing the candidate worker vector set to the attribute vector set for the given position to determine whether the candidate worker associated with the candidate worker vector set is qualified for the given position; and
      extending, in response to determining that the candidate worker is qualified for the given position, an offer for the given position to the candidate worker.
11. The system of embodiment 10,
   wherein the generation of the labeled worker datasets comprises, for each of the workers, determining a performance of the worker, wherein the labeled worker dataset for the worker comprises a performance label corresponding to the performance of the worker, and
   wherein the attribute vector set for a given position is determined based on the vector sets of the labeled worker datasets of a position cluster of the position clusters that are associated with the given position and that have a performance label that is indicative of a relatively high level of performance.
12. The system of embodiment 10 or embodiment 11,
   wherein the attribute vector set for a given position comprises a single vector representation of multiple vectors generated based on the documents associated with workers, and
   wherein the candidate worker vector set comprises a single vector representation of multiple vectors generated based on the candidate documents associated with the candidate worker.
13. The system of any one of embodiments 10-12, the operations further comprising:
   generating, based on the labeled worker datasets of a position cluster associated with the given position, a set of worker attributes for the position;
   generating, based on the set of worker attributes for the position, a worker position request; and
   publishing the worker position request.
14. The system of embodiment 13, wherein the candidate documents associated with the candidate worker are provided in association with the worker position request published.
15. The system of embodiment 13 or embodiment 14, wherein the set of worker attributes for the position comprise keywords or values.
16. The system of any one of embodiments 10-15, further comprising:
   generating, based on the labeled worker datasets of a position cluster associated with the given position, a set of worker attributes for the position;
   identifying, based on the set of worker attributes for the position, a set of potential candidate workers, the set of potential candidate workers including the candidate worker; and
   identifying, from the set of potential candidate workers, the candidate worker for assessment,
   wherein the vectorizing of the candidate documents is performed responsive to selecting the candidate worker for assessment.
17. The system of embodiment 16, wherein set of worker attributes for the position comprise threshold criteria, and wherein the set of potential candidate workers is selected based on comparison of structured data of candidate documents associated with the set of potential candidate workers to the threshold criteria.
18. The system of any one of embodiments 10-17, wherein the documents comprise unstructured text, and the vectorizing comprising, for each of the documents obtained, generating a vector representation of the document based on the unstructured text of the document.
19. Non-transitory computer readable medium comprising program instructions stored thereon that are executable by the processor to perform the method of any one of embodiments 1-9.
20. A method comprising:
   vectorizing documents associated with workers to generate vector representations of the documents;
   generating, based on the vector representations of the documents, worker vector sets; generating, based on the worker vector sets, labeled worker datasets comprising position labels;
   clustering, based on the position labels, the labeled worker datasets to determine position clusters;
   determining, based on the labeled worker datasets, an attribute vector set for a given position; obtaining candidate documents associated with a candidate worker;
   vectorizing the candidate documents to generate vector representations of the candidate documents;
   generating, based on the vector representations of the documents, a candidate worker vector set;
   comparing the candidate worker vector set to the attribute vector set for the given position to determine whether the candidate worker associated with the candidate worker vector set is qualified for the given position.
21. A system comprising:
   a processor; and
   non-transitory computer readable medium comprising program instructions stored thereon that are executable by the processor to perform the following operations:
      vectorizing documents associated with workers to generate vector representations of the documents;
      generating, based on the vector representations of the documents, worker vector sets; generating, based on the worker vector sets, labeled worker datasets comprising position labels;
      clustering, based on the position labels, the labeled worker datasets to determine position clusters;
      determining, based on the labeled worker datasets, an attribute vector set for a given position; obtaining candidate documents associated with a candidate worker;
      vectorizing the candidate documents to generate vector representations of the candidate documents;
      generating, based on the vector representations of the documents, a candidate worker vector set;
      comparing the candidate worker vector set to the attribute vector set for the given position to determine whether the candidate worker associated with the candidate worker vector set is qualified for the given position.
22. Non-transitory computer readable medium comprising program instructions stored thereon that are executable by the processor to perform the method of embodiments 18.

1. A method of workforce management, the method comprising:
obtaining documents associated with workers;
vectorizing the documents to generate vector representations of the documents, the vectorizing comprising, for each of the documents obtained, generating a vector representation of the document;
generating, based on the vector representations of the documents, worker vector sets, the generating of the worker vector sets comprising, for each of the workers:
identifying documents associated with the worker; and
generating a worker vector set based on the vector representations of the documents identified as associated with the worker;
generating, based on the worker vector sets, labeled worker datasets comprising position labels and attribute labels, the generation of the labeled worker datasets comprising, for each of the workers:
determining a position of the worker;
determining an attribute of the worker; and
generating a labeled worker dataset comprising:
the vector set for the worker; and
a position label corresponding to the position of the worker determined; and
an attribute label corresponding to the attribute of the worker determined;
clustering, based on the position and attribute labels, the labeled worker datasets to determine position clusters, each of the position clusters associated with a position and comprising a set of one or more labeled worker datasets comprising a position label that corresponds to the position and an attribute label that satisfies criteria for the attribute;
determining, based on the vector sets of the labeled worker datasets, an attribute vector set for a given position, the attribute vector set for the given position determined based on the worker vectors sets of a position cluster of the position clusters that is associated with the given position;
obtaining candidate documents associated with a candidate worker;
vectorizing the candidate documents to generate vector representations of the candidate documents, the vectorizing comprising, for each of the candidate documents, generating a vector representation of the candidate document;
generating, based on the vector representations of the candidate documents, a candidate worker vector set;
comparing the candidate worker vector set to the attribute vector set for the given position to determine whether the candidate worker associated with the candidate worker vector set is qualified for the given position; and
extending, in response to determining that the candidate worker is qualified for the given position, an offer for the given position to the candidate worker.

2. The method of claim 1,
wherein the generation of the labeled worker datasets comprises, for each of the workers, determining a performance of the worker, wherein the labeled worker dataset for the worker comprises a performance label corresponding to the performance of the worker, and
wherein the attribute vector set for a given position is determined based on the vector sets of the labeled worker datasets of a position cluster of the position clusters that are associated with the given position and that have a performance label that is indicative of a relatively high level of performance.

3. The method of claim 1,
wherein the attribute vector set for a given position comprises a single vector representation of multiple vectors generated based on the documents associated with workers, and
wherein the candidate worker vector set comprises a single vector representation of multiple vectors generated based on the candidate documents associated with the candidate worker.

4. The method of claim 1, further comprising:
generating, based on the labeled worker datasets of a position cluster associated with the given position, a set of worker attributes for the position;
generating, based on the set of worker attributes for the position, a worker position request; and
publishing the worker position request.

5. The method of claim 4, wherein the candidate documents associated with the candidate worker are provided in association with the worker position request published.

6. The method of claim 4, wherein the set of worker attributes for the position comprise keywords or values.

7. The method of claim 1, further comprising:
generating, based on the labeled worker datasets of a position cluster associated with the given position, a set of worker attributes for the position;
identifying, based on the set of worker attributes for the position, a set of potential candidate workers, the set of potential candidate workers including the candidate worker; and
identifying, from the set of potential candidate workers, the candidate worker for assessment,
wherein the vectorizing of the candidate documents is performed responsive to selecting the candidate worker for assessment.

8. The method of claim 7, wherein set of worker attributes for the position comprise threshold criteria, and wherein the set of potential candidate workers is selected based on comparison of structured data of candidate documents associated with the set of potential candidate workers to the threshold criteria.

9. The method of claim 1, wherein the documents comprise unstructured text, and the vectorizing comprising, for each of the documents obtained, generating a vector representation of the document based on the unstructured text of the document.

10. A workforce management system comprising:
a processor; and
non-transitory computer readable medium comprising program instructions stored thereon that are executable by the processor to perform the following operations for workforce management:
obtaining documents associated with workers;
vectorizing the documents to generate vector representations of the documents, the vectorizing comprising, for each of the documents obtained, generating a vector representation of the document;
generating, based on the vector representations of the documents, worker vector sets, the generating of the worker vector sets comprising, for each of the workers:
identifying documents associated with the worker; and
generating a worker vector set based on the vector representations of the documents identified as associated with the worker;
generating, based on the worker vector sets, labeled worker datasets comprising position labels and attribute labels, the generation of the labeled worker datasets comprising, for each of the workers:
determining a position of the worker;
determining an attribute of the worker; and
generating a labeled worker dataset comprising:
the vector set for the worker; and
a position label corresponding to the position of the worker determined; and
an attribute label corresponding to the attribute of the worker determined;
clustering, based on the position and attribute labels, the labeled worker datasets to determine position clusters, each of the position clusters associated with a position and comprising a set of one or more labeled worker datasets comprising a position label that corresponds to the position and an attribute label that satisfies criteria for the attribute;
determining, based on the vector sets of the labeled worker datasets, an attribute vector set for a given position, the attribute vector set for the given position determined based on the worker vectors sets of a position cluster of the position clusters that is associated with the given position;
obtaining candidate documents associated with a candidate worker;
vectorizing the candidate documents to generate vector representations of the candidate documents, the vectorizing comprising, for each of the candidate documents, generating a vector representation of the candidate document;
generating, based on the vector representations of the candidate documents, a candidate worker vector set;
comparing the candidate worker vector set to the attribute vector set for the given position to determine whether the candidate worker associated with the candidate worker vector set is qualified for the given position; and
extending, in response to determining that the candidate worker is qualified for the given position, an offer for the given position to the candidate worker.

11. The system of claim 10,
wherein the generation of the labeled worker datasets comprises, for each of the workers, determining a performance of the worker, wherein the labeled worker dataset for the worker comprises a performance label corresponding to the performance of the worker, and
wherein the attribute vector set for a given position is determined based on the vector sets of the labeled worker datasets of a position cluster of the position clusters that are associated with the given position and that have a performance label that is indicative of a relatively high level of performance.

12. The system of claim 10,
wherein the attribute vector set for a given position comprises a single vector representation of multiple vectors generated based on the documents associated with workers, and
wherein the candidate worker vector set comprises a single vector representation of multiple vectors generated based on the candidate documents associated with the candidate worker.

13. The system of claim 10, the operations further comprising:
generating, based on the labeled worker datasets of a position cluster associated with the given position, a set of worker attributes for the position;
generating, based on the set of worker attributes for the position, a worker position request; and
publishing the worker position request.

14. The system of claim 13, wherein the candidate documents associated with the candidate worker are provided in association with the worker position request published.

15. The system of claim 13, wherein the set of worker attributes for the position comprise keywords or values.

16. The system of claim 10, further comprising:
generating, based on the labeled worker datasets of a position cluster associated with the given position, a set of worker attributes for the position;
identifying, based on the set of worker attributes for the position, a set of potential candidate workers, the set of potential candidate workers including the candidate worker; and
identifying, from the set of potential candidate workers, the candidate worker for assessment,
wherein the vectorizing of the candidate documents is performed responsive to selecting the candidate worker for assessment.

17. The system of claim 16, wherein set of worker attributes for the position comprise threshold criteria, and wherein the set of potential candidate workers is selected based on comparison of structured data of candidate documents associated with the set of potential candidate workers to the threshold criteria.

18. The system of claims 10, wherein the documents comprise unstructured text, and the vectorizing comprising, for each of the documents obtained, generating a vector representation of the document based on the unstructured text of the document.

19. Non-transitory computer readable medium comprising program instructions stored thereon that are executable by the processor to perform the following operations for workforce management:
obtaining documents associated with workers;
vectorizing the documents to generate vector representations of the documents, the vectorizing comprising, for each of the documents obtained, generating a vector representation of the document;
generating, based on the vector representations of the documents, worker vector sets, the generating of the worker vector sets comprising, for each of the workers:
identifying documents associated with the worker; and
generating a worker vector set based on the vector representations of the documents identified as associated with the worker;
generating, based on the worker vector sets, labeled worker datasets comprising position labels and attribute labels, the generation of the labeled worker datasets comprising, for each of the workers:
determining a position of the worker;
determining an attribute of the worker; and
generating a labeled worker dataset comprising:
the vector set for the worker; and
a position label corresponding to the position of the worker determined; and
an attribute label corresponding to the attribute of the worker determined;
clustering, based on the position and attribute labels, the labeled worker datasets to determine position clusters, each of the position clusters associated with a position and comprising a set of one or more labeled worker datasets comprising a position label that corresponds to the position and an attribute label that satisfies criteria for the attribute;
determining, based on the vector sets of the labeled worker datasets, an attribute vector set for a given position, the attribute vector set for the given position determined based on the worker vectors sets of a position cluster of the position clusters that is associated with the given position;
obtaining candidate documents associated with a candidate worker;
vectorizing the candidate documents to generate vector representations of the candidate documents, the vectorizing comprising, for each of the candidate documents, generating a vector representation of the candidate document;
generating, based on the vector representations of the candidate documents, a candidate worker vector set;
comparing the candidate worker vector set to the attribute vector set for the given position to determine whether the candidate worker associated with the candidate worker vector set is qualified for the given position; and
extending, in response to determining that the candidate worker is qualified for the given position, an offer for the given position to the candidate worker.
